(19) United States
(12) Patent Application Publication
(10) Pub. No.: US 2025/0291266 A1
(43) Pub. Date: Sep. 18, 2025

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: NAO HIGUCHI, Shizuoka (JP); TOMOHITO ISHIDA, Shizuoka (JP); SHUNTARO WATANABE, Kanagawa (JP); TAICHI SATO, Shizuoka (JP); TSUTOMU NISHIDA, Shizuoka (JP); KOHEI MAKISUMI, Shizuoka (JP); MASATADA HIROTA, Shizuoka (JP); KENTARO TANAKA, Shizuoka (JP)

(21) Appl. No.: 19/221,310

(22) Filed: May 28, 2025

Related U.S. Application Data
(63) Continuation of application No. PCT/JP2023/041961, filed on Nov. 22, 2023.

(30) Foreign Application Priority Data
Nov. 30, 2022 (JP) 2022-191506
Apr. 26, 2023 (JP) 2023-072643

(51) Int. Cl. G03G 5/05; G03G 5/087; G03G 21/18

(52) U.S. Cl. CPC G03G 5/0546; G03G 5/0596; G03G 5/087; G03G 21/1814

(57) ABSTRACT

An electrophotographic photosensitive member includes a surface layer containing a binder resin and an inorganic particle. A value of a ratio of a volume of the inorganic particle to a volume of the binder resin in the surface layer is 1.0 or more and 4.0 or less. The binder resin is a polymerization product of a composition containing a polymerizable monomer having a polymerizable functional group. The composition contains a (meth)acrylic monomer having 6 or more polymerizable functional groups. The (meth)acrylic monomer has a molecular weight of 540 or more and 1,300 or less. A content of the (meth)acrylic monomer in the composition is 40 mol % or more with respect to a total molar number of the polymerizable monomer in the composition. A surface of the surface layer has an arithmetic average roughness Rz of 150 nm or more and 400 nm or less.

### CROSS-REFERENCE TO RELATED APPLICATIONS

This application is a Continuation of International Patent Application No. PCT/JP2023/041961, filed Nov. 22, 2023, which claims the benefit of Japanese Patent Application No. 2022-191506, filed Nov. 30, 2022, and Japanese Patent Application No. 2023-072643, filed Apr. 26, 2023, all of which are hereby incorporated by reference herein in their entirety.

### BACKGROUND OF THE INVENTION

### Field of the Invention

The present invention relates to an electrophotographic photosensitive member, and a process cartridge and an electrophotographic apparatus each including the electrophotographic photosensitive member.

### Description of the Related Art

In recent years, in the field of an electrophotographic apparatus, an increase in number of printable sheets has been required from the viewpoint of an improvement in usability through a reduction in maintenance frequency. To achieve the increase in number of printable sheets in the electrophotographic apparatus, the lifetime of an electrophotographic photosensitive member needs to be increased. In order to lengthen the lifetime of the electrophotographic photosensitive member, a characteristic contributing to its functionality needs to be stabilized during a time period from the initial stage of printing (the stage at which the number of printed sheets is small) to the later stage of printing (the stage after a large number of sheets have been printed).

An image forming method of an electrophotographic system includes a charging step, an exposing step, a developing step, and a transferring step. In the electrophotographic apparatus, the electrophotographic photosensitive member and an abutting member such as an intermediate transfer belt are brought into abutment with each other at an appropriate relative rotation speed.

In a related-art electrophotographic photosensitive member, along with an increase in number of printed sheets, the abrasion of its surface due to rubbing with a cleaning member and the like, and the contamination of the surface with toner and an external additive become apparent, and surface properties, such as a dynamic friction coefficient and tackiness, change. That is, the surface characteristics of the electrophotographic photosensitive member change between the initial stage of printing and the later stage of printing. In a transferring step, in the initial stage of printing, the electrophotographic photosensitive member and an abutting member are operated at an appropriate relative rotation speed. However, in the later stage of printing, the dynamic friction coefficient and tackiness of the electrophotographic photosensitive member change, and hence the electrophotographic photosensitive member and the abutting member cannot maintain the appropriate relative rotation speed, resulting in occurrence of unintended slipping. The slipping inhibits the normal rotation to cause exposure blurring in which the appropriate formation of an electrostatic latent image in an exposing step is not performed. The exposure blurring causes disturbance in the formation of the electrostatic latent image, resulting in a horizontal streak that is an image failure in an image to be output.

The above-mentioned problem is particularly significant in an electrophotographic apparatus required to have a lifetime longer than that in the related art. Examples of a measure for solving this problem include the suppression of abrasion of the surface of the electrophotographic photosensitive member, an improvement in resistance to contamination with toner and the like, and the setting of initial characteristics of the electrophotographic photosensitive member considering that changes in characteristics are not increased from the initial stage of printing to the later stage of printing. In order to achieve such solution measures, for example, the following technologies have been proposed.

In Japanese Patent Application Laid-Open No. 2014-178424, there is a proposal of the following technology: in order to suppress the abrasion of the surface of an electrophotographic photosensitive member by a cleaning blade that is a kind of cleaning member, an aggregate of metal oxide fine particles is localized in a surface layer of the electrophotographic photosensitive member.

In Japanese Patent Application Laid-Open No. 2005-62830, in order to prevent an increase in friction coefficient of the surface of an electrophotographic photosensitive member that occurs at the time of long-term printing or mass printing, a predetermined amount of fluororesin particles and a fluorine-based surfactant are incorporated into a surface layer of the electrophotographic photosensitive member. In Japanese Patent Application Laid-Open No. 2005-62830, there is a proposal of the following technology: the surface free energy of the fluororesin particles is designed to be larger than the surface free energy of a mixture of the fluorine-based surfactant and a binder resin.

However, in Japanese Patent Application Laid-Open No. 2014-178424, in the later stage of printing in an electrophotographic apparatus in which the number of printed sheets is larger than that in the related art, a change in dynamic friction coefficient becomes larger than that in the initial stage of printing due to the contamination of the surface of the electrophotographic photosensitive member with toner and the like, and a horizontal streak due to the slipping of the electrophotographic photosensitive member occurs.

In Japanese Patent Application Laid-Open No. 2005-62830, a horizontal streak due to the slipping of the electrophotographic photosensitive member is caused by the deterioration of the binder resin used in the surface layer of the electrophotographic photosensitive member.

### SUMMARY OF THE INVENTION

The inventors of the present invention have made extensive investigations, and as a result, have found a method of designing a surface layer of an electrophotographic photosensitive member in which the exposure blurring that occurs in the later stage of printing is suppressed.

That is, according to the present invention, there is provided an electrophotographic photosensitive member including a surface layer containing a binder resin and an inorganic particle, wherein a value of a ratio of a volume of the inorganic particle to a volume of the binder resin in the surface layer is 1.0 or more and 4.0 or less, wherein the binder resin is a polymerization product of a composition containing a polymerizable monomer having a polymerizable functional group, wherein the composition contains a (meth)acrylic monomer having 6 or more polymerizable functional groups as the polymerizable monomer, wherein the (meth)acrylic monomer having 6 or more polymerizable functional groups has a molecular weight of 540 or more and 1,300 or less, wherein a content of the (meth)acrylic monomer having 6 or more polymerizable functional groups in the composition is 40 mol % or more with respect to a total molar number of the polymerizable monomer in the composition, and wherein a surface of the surface layer has an arithmetic average roughness Rz of 150 nm or more and 400 nm or less.

With such configuration, in the later stage of printing in the electrophotographic apparatus in which the number of printed sheets is larger than that in the related art, the suppression of a horizontal streak due to the exposure blurring of the electrophotographic photosensitive member has been achieved.

An object of the present invention is to provide an electrophotographic photosensitive member that can resist printing of a volume larger than that in the related art by creating an appropriate surface state for the electrophotographic photosensitive member through use of a (meth)acrylic monomer having 6 or more polymerizable functional groups and an inorganic particle in the surface design of the electrophotographic photosensitive member.

The above-mentioned object is achieved by the present invention described below. That is, an electrophotographic photosensitive member according to the present invention is an electrophotographic photosensitive member including a surface layer containing a binder resin and an inorganic particle, wherein a value of a ratio of a volume of the inorganic particle to a volume of the binder resin in the surface layer is 1.0 or more and 4.0 or less, wherein the binder resin is a polymerization product of a composition containing a polymerizable monomer having a polymerizable functional group, wherein the composition contains a (meth)acrylic monomer having 6 or more polymerizable functional groups as the polymerizable monomer, wherein the (meth)acrylic monomer having 6 or more polymerizable functional groups has a molecular weight of 540 or more and 1,300 or less, wherein a content of the (meth)acrylic monomer having 6 or more polymerizable functional groups in the composition is 40 mol % or more with respect to a total molar number of the polymerizable monomer in the composition, and wherein a surface of the surface layer has an arithmetic average roughness Rz of 150 nm or more and 400 nm or less.

In addition, according to the present invention, there is provided a process cartridge including: the above-mentioned electrophotographic photosensitive member; and at least one unit selected from the group consisting of: a charging unit; a developing unit; and a cleaning unit, the process cartridge integrally supporting the electrophotographic photosensitive member and the at least one unit, and being detachably attachable onto a main body of an electrophotographic apparatus.

In addition, according to the present invention, there is provided an electrophotographic apparatus including: the above-mentioned electrophotographic photosensitive member; and a charging unit, an exposing unit, a developing unit, and a transfer unit.

Further features of the present invention will become apparent from the following description of exemplary embodiments with reference to the attached drawings.

### BRIEF DESCRIPTION OF THE DRAWINGS

FIG. 1 is an illustration of an example of the layer configuration of an electrophotographic photosensitive member according to the present invention.

FIG. 2 is a view for illustrating an example of the schematic configuration of an electrophotographic apparatus including a process cartridge that includes an electrophotographic photosensitive member and a charging unit.

FIG. 3 is a schematic view of a tackiness evaluation apparatus.

### DESCRIPTION OF THE EMBODIMENTS

An exemplary embodiment of the present invention is described below.

### [Electrophotographic Photosensitive Member]

An electrophotographic photosensitive member of the present invention includes a support, and a charge-generating layer, a charge-transporting layer, and a surface layer containing a particle, the layers being arranged on the support. Although the electrophotographic photosensitive member according to the present invention may be used as a cylindrical electrophotographic photosensitive member obtained by forming the charge-generating layer, the charge-transporting layer, and the surface layer on a cylindrical support, a belt shape or a sheet shape is permitted.

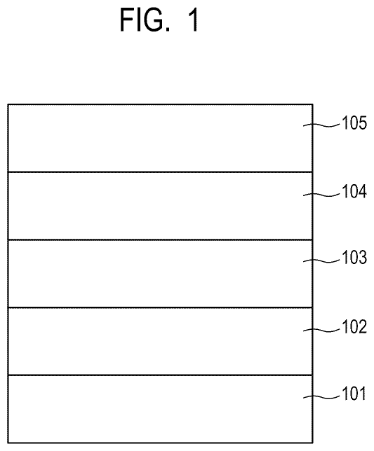

FIG. 1 is a view for illustrating an example of the layer configuration of the electrophotographic photosensitive member. In FIG. 1, a support is represented by reference symbol 101, an undercoat layer is represented by reference symbol 102, a charge-generating layer is represented by reference symbol 103, and a charge-transporting layer is represented by reference symbol 104. The surface layer according to the present invention is represented by reference symbol 105.

The electrophotographic photosensitive member of the present invention may be used in an image forming method including: a charging step of charging the surface of the electrophotographic photosensitive member; an exposing step of exposing the charged electrophotographic photosensitive member to form an electrostatic latent image; a developing step of supplying toner to the electrophotographic photosensitive member having formed thereon the electrostatic latent image to form a toner image; a transferring step of transferring the toner image formed on the electrophotographic photosensitive member; and a cleaning step of removing the toner remaining on the electrophotographic photosensitive member in the transferring step.

In addition, the electrophotographic photosensitive member of the present invention may be used in such an image forming method that the cleaning step is omitted from the image forming method in addition to the image forming method.

As a method of producing the electrophotographic photosensitive member of the present invention, there is given a method including preparing coating liquids for the respective layers to be described later, applying the liquids in a desired order of layers, and drying the liquids. In this case, examples of a method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

The present invention is directed to an electrophotographic photosensitive member including a surface layer containing a binder resin and an inorganic particle, the electrophotographic photosensitive member satisfying the following: a value of a ratio of a volume of the inorganic particle to a volume of the binder resin in the surface layer is 1.0 or more and 4.0 or less; the binder resin is a polymerization product of a composition containing a polymerizable monomer having a polymerizable functional group; the composition contains a (meth)acrylic monomer having 6 or more polymerizable functional groups as the polymerizable monomer; the (meth)acrylic monomer having 6 or more polymerizable functional groups has a molecular weight of 540 or more and 1,300 or less; a content of the (meth)acrylic monomer having 6 or more polymerizable functional groups in the composition is 40 mol % or more with respect to a total molar number of the polymerizable monomer in the composition; and a surface of the surface layer has an arithmetic average roughness Rz of 150 nm or more and 400 nm or less.

The above-mentioned configuration can achieve the suppression of a horizontal streak due to the exposure blurring in the later stage of printing in the electrophotographic apparatus in which the number of printed sheets is larger than that in the related art. The mechanism via which the problem is solved by the configuration of the present invention is not clear, but is presumed as described below.

The horizontal streak due to the exposure blurring in the later stage of printing in the electrophotographic apparatus in which the number of printed sheets is larger than that in the related art is influenced by changes in characteristics of the surface of the electrophotographic photosensitive member. The changes in characteristics of the surface of the electrophotographic photosensitive member are mainly caused by the following two causes.

A first cause is the abrasion of the surface of the electrophotographic photosensitive member. Along with mass printing, the electrophotographic photosensitive member is rubbed with, for example, a cleaning member for a long time period. Thus, a surface shape designed through use of, for example, treatment to which the surface of the electrophotographic photosensitive member has been subjected or particles is broken, and hence a surface state of the electrophotographic photosensitive member gradually changes with increasing number of printed sheets. Thus, the dynamic friction coefficient and tackiness of the surface of the electrophotographic photosensitive member change.

A second cause is the contamination of the surface of the electrophotographic photosensitive member with toner or the like. The number of opportunities for the surface of the electrophotographic photosensitive member to be brought into contact with a contaminant, such as the toner, an external additive, or paper powder, is increased by mass printing. Thus, the surface of the electrophotographic photosensitive member is contaminated, and hence its surface state gradually changes with increasing number of printed sheets. Thus, the dynamic friction coefficient and tackiness of the surface of the electrophotographic photosensitive member change.

To suppress the above-mentioned changes in characteristics of the surface of the electrophotographic photosensitive member, the following methods are available.

That is, there is the suppression of abrasion of the surface of the electrophotographic photosensitive member, an improvement in resistance to contamination with toner and the like, or the design of initial characteristics of the electrophotographic photosensitive member considering that changes in characteristics are not increased from the initial stage of printing to the later stage of printing even when abrasion or contamination occurs.

In the present invention, a decrease in contact area is achieved by forming an uneven shape caused by the inorganic particle through the setting of the value of the ratio of the volume of the inorganic particle to the volume of the binder resin to 1.0 or more and 4.0 or less in the surface layer of the electrophotographic photosensitive member. As a result, a decrease in dynamic friction coefficient is achieved.

In addition, three-dimensional polymerization is allowed to occur by incorporating the (meth)acrylic monomer having 6 or more polymerizable functional groups as a composition of the binder resin. The three-dimensional polymerization has a suppressing effect on the deformation of the resin caused by an external pressure, and causes a decrease in viscosity, and an increase in hardness, of the resin. As a result, a decrease in tackiness is achieved. In particular, when the (meth)acrylic monomer having 6 or more polymerizable functional groups is incorporated, the three-dimensional polymerization can be allowed to occur more densely as compared to the case in which a (meth)acrylic monomer having less than 6 polymerizable functional groups is incorporated, and a decrease in viscosity, and an increase in hardness, of the resin can be caused more easily. As a result, an excellent decrease in tackiness can be achieved.

In addition, the molecular weight of the (meth)acrylic monomer having 6 or more polymerizable functional groups is set to 540 or more and 1,300 or less, and the content thereof in the composition is set to 40 mol % or more with respect to the total molar number of the polymerizable monomer in the composition. Thus, the distance between the polymerization reaction points is controlled to achieve abrasion resistance and a decrease in tackiness by the suppression of the viscosity of the binder resin.

In addition, the arithmetic average roughness Rz of the surface of the surface layer is set to preferably 150 nm or more and 400 nm or less, more preferably 150 nm or more and 350 nm or less. A decrease in contact area is achieved by forming an uneven shape through the control of the Rz. As a result, a decrease in dynamic friction coefficient is achieved.

Further, the dynamic friction coefficient of the surface layer is set to preferably 0.70 or less, more preferably 0.65 or less, still more preferably 0.62 or less. When the dynamic friction coefficient falls within the above-mentioned ranges, the dynamic friction coefficient can be kept lower than that of a related-art electrophotographic photosensitive member at the time of the initial stage of printing, and a change amount of a decrease in dynamic friction coefficient due to the surface contamination with toner and the like in the later stage of printing can be suppressed.

In addition, the tackiness index of the surface layer is set to preferably 0.060 or less, more preferably 0.050 or less, still more preferably 0.045 or less. When the tackiness index falls within the above-mentioned ranges, the suppression of abrasion due to mass printing and a reduction in adhesion amount of a contaminant such as toner can be achieved.

Further, the number-based average primary particle diameter of the inorganic particle contained in the surface layer is set to preferably 80 nm or more and 300 nm or less, more preferably 100 nm or more and 200 nm or less. When the number-based average primary particle diameter falls within the above-mentioned ranges, the desorption of the inorganic particle due to mass printing can be suppressed even while an uneven shape is formed.

The surface layer contains inorganic particle A and inorganic particle B having different number-based average primary particle diameters, and the number-based average primary particle diameter of the inorganic particle B is smaller than the number-based average primary particle diameter of the inorganic particle A. When the number-based average primary particle diameter of the inorganic particle A is represented by DA [nm], and the number-based average primary particle diameter of the inorganic particle B is represented by DB [nm], it is preferred that the DA and the DB satisfy the following formulae (i) and (ii). When the DA and the DB satisfy the formulae (i) and (ii), gaps generated in lamination of the inorganic particle A can be filled with the inorganic particle B, and the desorption of the particles for forming protrusions can be suppressed.

$$1.3 \leq DA / DB \leq 3.8 \qquad ( i )$$

$$100 \leq DA \leq 300 \qquad ( ii )$$

The inorganic particle A is liable to be brought into contact with another member, and hence is preferably silica particle that is strong against rubbing and contamination.

Further, it is preferred that polymerizable monomer A represented by the following formula (1) be further incorporated into the composition of the binder resin as a polymerizable monomer. When the polymerizable monomer A is incorporated into the composition of the binder resin, the end of the (meth)acrylic polymer can be polymerized with the polymerizable monomer A. Accordingly, the binding property between the inorganic particle and the binder resin can be improved, and the desorption of the inorganic particle in the later stage of printing can be suppressed.

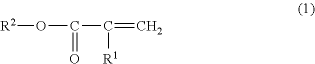

In the formula (1), R¹ represents a hydrogen atom or a methyl group, and R² represents an alkyl group having 10 to 20 or less carbon atoms.

The polymerizable monomer A is a (meth)acrylic acid ester having an alkyl group having 10 or more and 20 or less carbon atoms. Examples of the polymerizable monomer A represented by the above-mentioned formula (1) include decyl (meth)acrylate, dodecyl (meth)acrylate (trivial name: lauryl (meth)acrylate), tetradecyl (meth)acrylate (trivial name: myristyl (meth)acrylate), hexadecyl (meth)acrylate (trivial name: cetyl (meth)acrylate), octadecyl (meth)acrylate (trivial name: stearyl (meth)acrylate), eicosyl (meth)acrylate (trivial name: eicosyl acrylate), and a (meth)acrylic acid ester having a branched alkyl group having 10 or more and 20 or less carbon atoms [e.g., 2-methyltetradecyl (meth)acrylate, 2-methylnonadecyl (meth)acrylate, or isostearyl (meth)acrylate].

Through use of the polymerizable monomer A, the end of a long-chain alkyl group becomes free in the polymer that is the binder resin, and the free state is suitable for surrounding the surface of each of the inorganic particle. In addition, an ester bond (—CO—C—) in the vicinity of the polymerizable functional group (CH₂═CR¹—) that influences the generation of a discharge product is isolated from an air layer in the vicinity of the surface layer of the electrophotographic photosensitive member by the long-chain alkyl group (—R²). Thus, the following additional effect can be expected: the generation of a discharge product due to the decomposition of the polymer that is the binder resin is suppressed.

As described above, the R² in the formula (1) represents an alkyl group having 10 or more and 20 or less carbon atoms. When the number of carbon atoms is 10 or more, the alkyl group is easily brought into contact with the inorganic particle for a long time period. As a result, an improving effect on the adhesiveness between the binder resin and the inorganic particle assumed to be due to the surrounding of the inorganic particle is enhanced. When the number of carbon atoms is 20 or less, the alkyl group becomes more mobile to increase the number of opportunities for the alkyl group to be brought into contact with the inorganic particle. As a result, the improving effect on the adhesiveness between the binder resin and the inorganic particle assumed to be due to the surrounding of the inorganic particle is enhanced. The R² preferably represents an alkyl group having 12 or more and 18 or less carbon atoms.

The content of the polymerizable monomer A in the above-mentioned polymerizable monomer composition is preferably less than 25 mass % with respect to the total mass of the polymerizable monomers contained in the polymerizable monomer composition. The phrase “total mass of the polymerizable monomers contained in the polymerizable monomer composition” means the total mass of all the polymerizable monomers when the polymerizable monomer A and a polymerizable monomer other than the polymerizable monomer A are contained in the polymerizable monomer composition. When the content of the polymerizable monomer A is less than 25 mass %, the improving effect on the adhesiveness between the binder resin and the inorganic particle can be enhanced while three-dimensional polymerization using the above-mentioned (meth)acrylic monomer having 6 or more polymerizable functional groups is allowed to occur more densely.

In addition, the average length Rsm of the elements of the surface of the surface layer is set to preferably 100 nm or more and 400 nm or less. When the average length Rsm of the elements falls within the above-mentioned ranges, the force applied to the protrusions formed of the inorganic particle can be set to be appropriate. When the Rsm is less than 100 nm, the number of the protrusions per unit area is increased to increase a contact area, and hence the dynamic friction coefficient is increased. When the Rsm is more than 400 nm, the number of the protrusions per unit area is decreased, and hence the force applied to each of the protrusions is increased. Thus, the abrasion of the protrusions and the desorption of the inorganic particle occur.

Further, mass printing is accompanied by rubbing with a cleaning member and the like, and contamination with toner and the like, and hence the inorganic particle A to be the protrusions in the surface layer of the electrophotographic photosensitive member is preferably silica particle that are strong against rubbing and contamination.

The above-mentioned mechanism is based on an assumption, and the assumption does not affect the technical scope of the present invention.

### <Binder Resin>

Examples of the form of the binder resin according to the present invention include the following forms.

Examples of the binder resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred. In addition, the surface layer of the present invention may be formed as a cured film by polymerizing a composition containing a monomer having a polymerizable functional group. A reaction at this time is, for example, a thermal polymerization reaction, a photopolymerization reaction, or a radiation polymerization reaction. Examples of the polymerizable functional group of the monomer having a polymerizable functional group include an acrylic group and a methacrylic group.

It is preferred that the binder resin of the surface layer contain a (meth)acrylic polymer that provides a surface layer having excellent rubbing resistance and high hardness. The monomer that forms a (meth)acrylic polymer is not particularly limited. However, in order to reduce the elasticity that contributes to tackiness, a polyfunctional (meth)acrylic monomer that may densely form a three-dimensional structure is preferably used.

Specific examples of the polyfunctional acrylate include pentaerythritol tri(meth)acrylate, pentaerythritol tetra(meth)acrylate, trimethylolpropane tri(meth)acrylate, ethylene oxide (EO)-modified trimethylolpropane tri(meth)acrylate, propylene oxide (PO)-modified trimethylolpropane tri(meth)acrylate, dipentaerythritol penta- and hexa(meth)acrylate, and isocyanuric acid EO-modified di- and tri(meth)acrylate.

In particular, in order to obtain excellent rubbing resistance and low tackiness as compared to those of the surface layer of the related-art electrophotographic photosensitive member, it is required that a (meth)acrylic polymer using a (meth)acrylic monomer having 6 or more polymerizable functional groups be used as the binder resin. Further, the polymerizable functional group is a (meth)acryloyl group.

In order to reduce the elasticity that contributes to tackiness, the molecular weight of the (meth)acrylic monomer having 6 or more polymerizable functional groups needs to be set to 540 or more and 1,300 or less. Further, the molecular weight is preferably set to 578 or more and 1,300 or less. Specific examples of the (meth)acrylic monomer having 6 or more polymerizable functional groups include polypentaerythritol polyacrylate (structural formula (1-1), n=1 to 2) and urethane acrylate (compounds represented by the following formulae (M-1) to (M-4)).

Examples of other acrylates include compounds represented by the following structural formulae (1-2) and (1-3).

In the structural formula (1-2), at least two of R²⁰¹, R²⁰⁵, and R²⁰⁹ each represent a group having a (meth)acryloyloxy group, and R²⁰¹, R²⁰⁵, and R²⁰⁹, which are not groups having (meth)acryloyloxy groups, and R²⁰² to R²⁰⁴, R²⁰⁶ to R²⁰⁸, and R²¹⁰ to R²¹² each represent a hydrogen atom or a methyl group.

In the structural formula (1-3), R²²¹ and R²³⁴ each represent a group having a (meth)acryloyloxy group, and R²²² to R²³³ each represent a hydrogen atom or a methyl group.

In the structural formulae (1-2) and (1-3), examples of the group having a (meth)acryloyloxy group include groups represented by formulae (L-1) to (L-5).

In the formulae (L-1) to (L-5), “*” represents a bonding site with another structure, A¹ and A² each represent any one of a hydrogen atom and the groups represented by the formulae (L-1) to (L-5), and B represents a hydrogen atom or a methyl group.

Examples of the compound represented by the structural formula (1-2) include the compounds represented by the formulae (M-1) and (M-2). In addition, examples of the compound represented by the structural formula (1-3) include the compounds represented by the formulae (M-3) and (M-4).

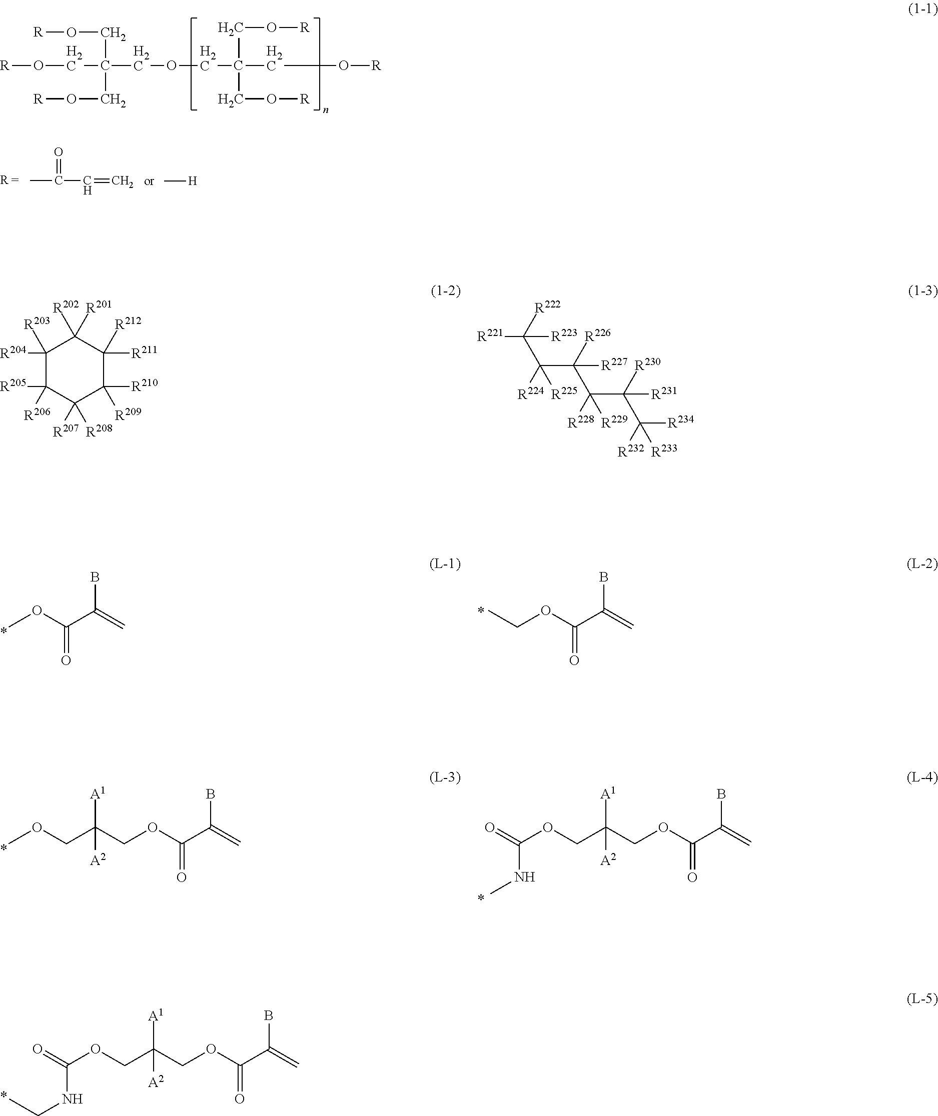

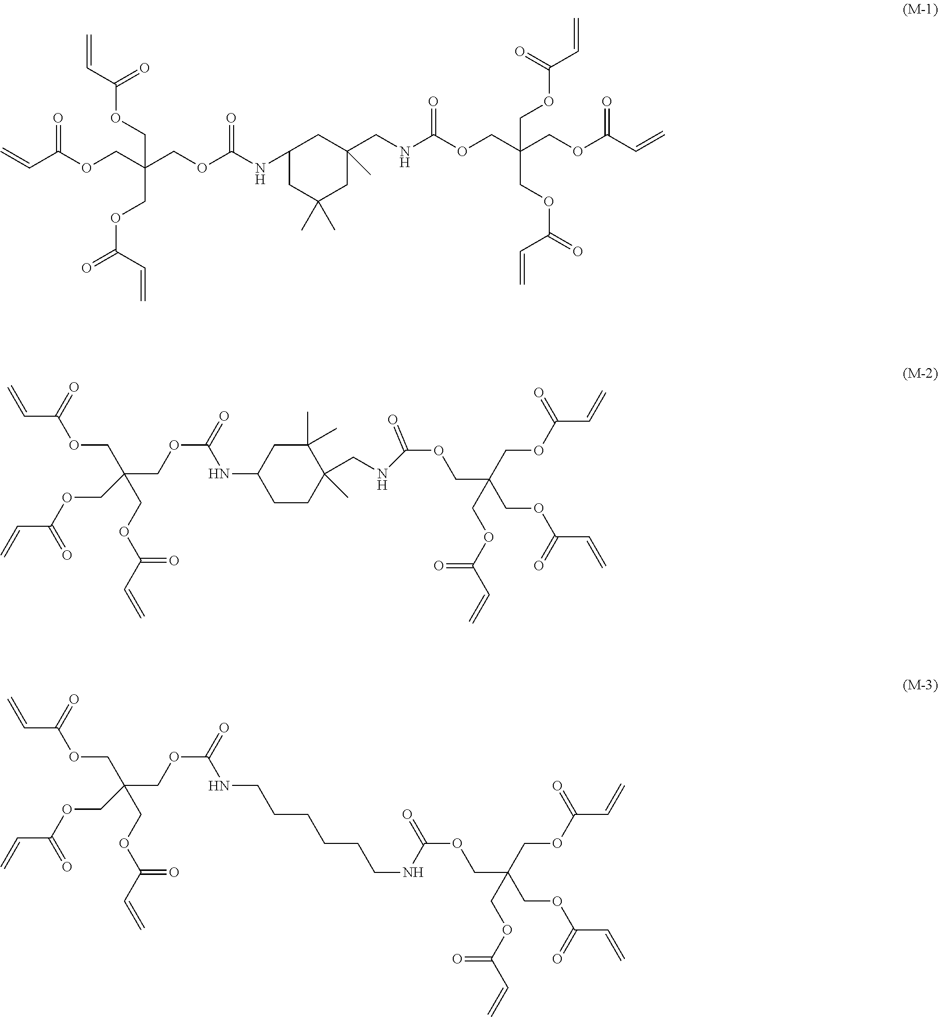

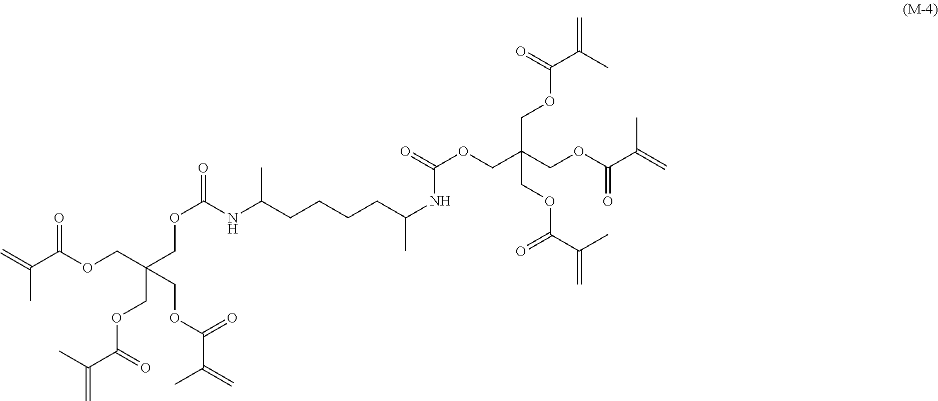 [SMILES: C=C(C)C(=O)OCC(COC(=O)NC(C)CCCCC(C)NC(=O)OCC(COC(=O)C(=C)C)(COC(=O)C(=C)C)COC(=O)C(=C)C)(COC(=O)C(=C)C)COC(=O)C(=C)C]

In order to suppress shrinkage at the time of the curing of a film of a curable composition and to adjust the viscosity to a suitable level for applying the curable composition, two or more kinds of monomers selected from the above-mentioned monomer group may be appropriately mixed and used.

Examples of a method of curing the binder resin include thermal curing, UV curing, and electron beam curing, but electron beam curing is preferred from the viewpoints of efficiency and productivity.

### <Inorganic Particle>

Examples of the inorganic particle to be used in the present invention include silica particle, metal oxide particle, and metal particle. The inorganic particle, which have low elasticity, and are advantageous in terms of the promotion of point contact between the toner and the photosensitive member, are preferably used as the particles of the surface layer of the electrophotographic photosensitive member of the present invention.

When the inorganic particle is used, silica particle out of the particles is preferred. The silica particle is expected to exhibit the following effect because the particle has a lower modulus of elasticity and a larger average circularity as compared to those of the other insulating particles: the particle promotes the point contact between the toner and the photosensitive member to alleviate the adhesive force of the toner.

Known silica fine particle may be used as the silica particle, and fine particles of dry silica and fine particles of wet silica may each be used. Of those, fine particles of wet silica obtained by a sol-gel method (hereinafter also referred to as “sol-gel silica”) are preferred.

The sol-gel silica used as the particle to be incorporated into the surface layer of the electrophotographic photosensitive member of the present invention may be hydrophilic, or its surface may be subjected to hydrophobic treatment.

A method for the hydrophobic treatment is, for example, a method including removing a solvent from a silica sol suspension in the sol-gel method to dry the suspension, and then treating the dried product with a hydrophobic treatment agent, or a method including directly adding the hydrophobic treatment agent to the silica sol suspension to dry and treat the suspension simultaneously. Of those, an approach including directly adding the hydrophobic treatment agent to the silica sol suspension is preferred from the viewpoints of the control of the half-width of the particle size distribution of the sol-gel silica and the control of the saturated moisture adsorption amount thereof.

Examples of the hydrophobic treatment agent include the following:
chlorosilanes, such as methyltrichlorosilane, dimethyldichlorosilane, trimethylchlorosilane, phenyltrichlorosilane, diphenyldichlorosilane, t-butyldimethylchlorosilane, and vinyltrichlorosilane;
alkoxysilanes, such as tetramethoxysilane, methyltrimethoxysilane, dimethyldimethoxysilane, phenyltrimethoxysilane, diphenyldimethoxysilane, O-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, and γ-(2-aminoethyl) aminopropylmethyldimethoxysilane;
silazanes, such as hexamethyldisilazane, hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane;
silicone oils, such as a dimethyl silicone oil, a methyl hydrogen silicone oil, a methyl phenyl silicone oil, an alkyl-modified silicone oil, a chloroalkyl-modified silicone oil, a chlorophenyl-modified silicone oil, a fatty acid-modified silicone oil, a polyether-modified silicone oil, an alkoxy-modified silicone oil, a carbinol-modified silicone oil, an amino-modified silicone oil, a fluorine-modified silicone oil, and an end reactive silicone oil;
siloxanes, such as hexamethylcyclotrisiloxane, octamethylcyclotetrasiloxane, decamethylcyclopentasiloxane, hexamethyldisiloxane, and octamethyltrisiloxane; and as fatty acids and metal salts thereof, long-chain fatty acids, such as undecylic acid, lauric acid, tridecylic acid, dodecylic acid, myristic acid, palmitic acid, pentadecylic acid, stearic acid, heptadecylic acid, arachic acid, montanic acid, oleic acid, linoleic acid, and arachidonic acid, and salts of these fatty acids and metals, such as zinc, iron, magnesium, aluminum, calcium, sodium, and lithium.

Of those, alkoxysilanes, silazanes, and silicone oils are each preferably used because the hydrophobic treatment is easily performed. Those hydrophobic treatment agents may be used alone or in combination thereof.

### <Solvent>

A solvent in which the binder resin, the inorganic particle, and an additive to be described later are stably dispersed or dissolved only needs to be appropriately selected. Specific examples thereof may include the following:
alcohols, such as methanol, ethanol, isopropanol, butanol, and octanol;
ketones, such as acetone and cyclohexanone;
esters, such as ethyl acetate, butyl acetate, ethyl lactate, γ-butyrolactone, propylene glycol monomethyl ether acetate, and propylene glycol monoethyl ether acetate;
ethers, such as ethylene glycol monomethyl ether and diethylene glycol monobutyl ether;
aromatic hydrocarbons, such as benzene, toluene, and xylene; and
amides, such as dimethylformamide, dimethylacetamide, and N-methylpyrrolidone.

Of those, methyl isobutyl ketone, methyl ethyl ketone, cyclohexanone, propylene glycol monomethyl ether acetate, propylene glycol monoethyl ether acetate, toluene, xylene, 2-butanone, or 4-methyl-2-pentanone may be suitably used. This is because each of those solvents can dissolve an acrylic polymer more uniformly and is quickly volatilized from the film of the curable composition.

In addition, a plurality of solvents may be used in combination for adjusting the drying rate of the film of a curable composition and adjusting the viscosity of the curable composition to a viscosity suitable for application.

### <Additive>

The surface layer in the present invention may contain an additive, such as an antioxidant, a UV absorber, a plasticizer, a leveling agent, a slipperiness-imparting agent, or an abrasion resistance-improving agent. Specific examples thereof include a hindered phenol compound, a hindered amine compound, a sulfur compound, a phosphorus compound, a benzophenone compound, a siloxane-modified resin, and a silicone oil.

### <Surface Layer>

The surface layer may be formed by: preparing a coating liquid for a surface layer containing the above-mentioned respective materials and a solvent; forming a coat of the liquid; and drying and/or curing the coat.

### <Support>

In the present invention, the electrophotographic photosensitive member preferably includes a support. In the present invention, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support. Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating with an electroconductive material.

### <Electroconductive Layer>

In the present invention, an electroconductive layer may be arranged on the support. The arrangement of the electroconductive layer can conceal flaws and unevenness in the surface of the support, and control the reflection of light on the surface of the support. The electroconductive layer preferably contains an electroconductive particle and a resin.

A material for the electroconductive particle is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particle, and in particular, titanium oxide, tin oxide, and zinc oxide are more preferably used.

When the metal oxide is used as the electroconductive particle, the surface of the metal oxide may be treated with a silane coupling agent or the like, or the metal oxide may be doped with an element, such as phosphorus or aluminum, or an oxide thereof.

In addition, the electroconductive particle may each have a laminate configuration obtained by covering a pre-covering particle made of, for example, titanium oxide, barium sulfate, or zinc oxide with a metal oxide different from the particle in composition. The covering is performed with, for example, a metal oxide such as tin oxide.

In addition, when the metal oxide is used as the electroconductive particle, their average primary particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a silicone oil, a resin particle, or a concealing agent such as titanium oxide.

The electroconductive layer has an average thickness of preferably 1 μm or more and 50 μm or less, particularly preferably 3 μm or more and 40 μm or less.

The electroconductive layer may be formed by: preparing a coating liquid for an electroconductive layer containing the above-mentioned respective materials and a solvent; forming a coat of the liquid; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. A dispersion method for dispersing the electroconductive particle in the coating liquid for an electroconductive layer is, for example, a method including using a paint shaker, a sand mill, a ball mill, or a liquid collision-type high-speed disperser.

### <Undercoat Layer>

In the present invention, an undercoat layer may be arranged on the support or the electroconductive layer.

The undercoat layer has an average thickness of preferably 0.1 μm or more and 50 μm or less, more preferably 0.2 μm or more and 40 μm or less, particularly preferably 0.3 μm or more and 30 μm or less.

A resin for the undercoat layer is, for example, a polyacrylic acid resin, a polyvinyl alcohol resin, a polyvinyl acetal resin, a polyethylene oxide resin, a polypropylene oxide resin, an ethyl cellulose resin, a methyl cellulose resin, a polyamide resin, a polyamic acid resin, a polyurethane resin, a polyimide resin, a polyamideimide resin, a polyvinylphenol resin, a melamine resin, a phenol resin, an epoxy resin, and an alkyd resin.

A resin having a structure in which a resin having a polymerizable functional group and a monomer having a polymerizable functional group are crosslinked with each other is also permitted.

In addition, the undercoat layer may contain an inorganic compound or an organic compound in addition to the resin.

Examples of the inorganic compound include a metal, an oxide, and a salt.

Examples of the metal include gold, silver, and aluminum. Examples of the oxide include zinc oxide, white lead, aluminum oxide, indium oxide, silicon oxide, zirconium oxide, tin oxide, titanium oxide, magnesium oxide, antimony oxide, bismuth oxide, indium tin oxide, tin oxide, and zirconium oxide. Examples of the salt include barium sulfate and strontium titanate.

Those inorganic compounds may each be present under a particle state in a film serving as the undercoat layer.

The number-average particle diameter of the particles of the inorganic compound is preferably 1 nm or more and 500 nm or less, more preferably 3 nm or more and 400 nm or less.

Those inorganic compounds may each have a laminated configuration including a core particle and a covering layer covering the particle.

The surfaces of those inorganic compounds may each be treated with, for example, a silicone oil, a silane compound, a silane coupling agent, or any other organosilicon compound, or an organotitanium compound. In addition, those inorganic compounds may each be doped with an element, such as tin, phosphorus, aluminum, or niobium.

Examples of the organic compound include an electron-transporting compound and an electroconductive polymer.

Examples of the electroconductive polymer include polythiophene, polyaniline, polyacetylene, polyphenylene, and polyethylenedioxythiophene.

Examples of the electron-transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound.

The electron-transporting material may have a polymerizable functional group and may be crosslinked with a resin having a functional group reactive with the functional group. Examples of the polymerizable functional group include a hydroxy group, a thiol group, an amino group, a carboxyl group, a vinyl group, an acryloyl group, a methacryloyl group, and an epoxy group.

Those organic compounds may each be present under a particle state in the film, or their surfaces may be treated.

Various additives including a leveling agent such as a silicone oil, a plasticizer, and a thickener may be added to the undercoat layer.

The undercoat layer is obtained by: preparing a coating liquid for an undercoat layer containing the above-mentioned materials; then applying the liquid onto the support or the electroconductive layer; and then drying or curing the coat.

A solvent at the time of the production of the coating liquid is, for example, an alcohol-based solvent, a ketone-based solvent, an ether-based solvent, an ester-based solvent, or an aromatic hydrocarbon-based solvent.

A dispersion method for dispersing the particles of the materials in the coating liquid is, for example, a method including using a paint shaker, a sand mill, a ball mill, or a liquid collision-type high-speed disperser.

### <Photosensitive Layer>

The photosensitive layers of the electrophotographic photosensitive member are mainly classified into (1) a laminate-type photosensitive layer and (2) a monolayer-type photosensitive layer. (1) The laminate-type photosensitive layer is a photosensitive layer having a charge-generating layer containing a charge-generating material and a charge-transporting layer containing a charge-transporting material. (2) The monolayer-type photosensitive layer is a photosensitive layer containing both of a charge-generating material and a charge-transporting material.

### (1) Laminate-Type Photosensitive Layer

The laminate-type photosensitive layer has the charge-generating layer and the charge-transporting layer.

### (1-1) Charge-Generating Layer

The charge-generating layer preferably contains the charge-generating material and a resin.

Examples of the charge-generating material include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating material in the charge-generating layer is preferably 40 mass % or more and 85 mass % or less, more preferably 60 mass % or more and 80 mass % or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer may be formed by: preparing a coating liquid for a charge-generating layer containing the above-mentioned respective materials and a solvent; forming a coat of the liquid on the undercoat layer; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

The charge-generating layer has a thickness of preferably 0.1 μm or more and 1.5 μm or less, more preferably 0.15 μm or more and 1.0 μm or less.

### (1-2) Charge-Transporting Layer

The charge-transporting layer preferably contains the charge-transporting material and a resin.

Examples of the charge-transporting material include a polycyclic aromatic compound, a heterocyclic compound, a hydrazone compound, a styryl compound, an enamine compound, a benzidine compound, a triarylamine compound, and a resin having a group derived from each of those materials. Of those, a triarylamine compound and a benzidine compound are preferred.

The content of the charge-transporting material in the charge-transporting layer is preferably 25 mass % or more and 70 mass % or less, more preferably 30 mass % or more and 55 mass % or less with respect to the total mass of the charge-transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting material and the resin is preferably from 4:10 to 20:10, more preferably from 5:10 to 12:10.

In addition, the charge-transporting layer may contain an additive, such as an antioxidant, a UV absorber, a plasticizer, a leveling agent, a slipperiness-imparting agent, or an abrasion resistance-improving agent. Specific examples thereof include a hindered phenol compound, a hindered amine compound, a sulfur compound, a phosphorus compound, a benzophenone compound, a siloxane-modified resin, a silicone oil, a fluororesin particle, a polystyrene resin particle, a polyethylene resin particle, silica particle, alumina particle, and boron nitride particle.

The charge-transporting layer may be formed by: preparing a coating liquid for a charge-transporting layer containing the above-mentioned respective materials and a solvent; forming a coat of the liquid on the charge-generating layer; and drying the coat. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

The charge-transporting layer has a thickness of preferably 3 μm or more and 50 μm or less, more preferably 5 μm or more and 40 μm or less, particularly preferably 10 μm or more and 30 μm or less.

### (2) Monolayer-Type Photosensitive Layer

The monolayer-type photosensitive layer may be formed by: preparing a coating liquid for a photosensitive layer containing the charge-generating material, the charge-transporting material, a resin, and a solvent; forming a coat of the liquid on the undercoat layer; and drying the coat. Examples of the charge-generating material, the charge-transporting material, and the resin are the same as those of the materials in the section “(1) Laminate-type Photosensitive Layer.”

The monolayer-type photosensitive layer has a thickness of preferably 10 μm or more and 45 μm or less, more preferably 25 μm or more and 35 μm or less.

### <Process Cartridge and Electrophotographic Apparatus>

The electrophotographic photosensitive member that has been described above may be included in a process cartridge integrally supporting at least one unit selected from the group consisting of: a charging unit; a developing unit; and a cleaning unit. The process cartridge is characterized in that the cartridge is detachably attachable onto the main body of an electrophotographic apparatus.

### (Configuration of Electrophotographic Apparatus)

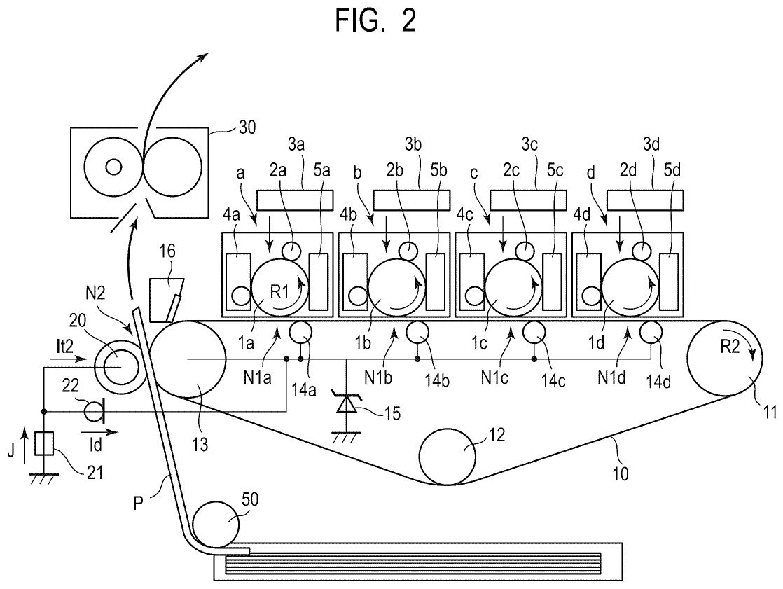

An example of the schematic configuration of an electrophotographic apparatus including a process cartridge including the electrophotographic photosensitive member of the present invention is illustrated in FIG. 2.

An electrophotographic apparatus of this embodiment is a so-called tandem-type electrophotographic apparatus provided with a plurality of image forming portions “a” to “d”. A first image forming portion “a” forms an image with yellow toner (Y). A second image forming portion “b” forms an image with magenta toner (M). A third image forming portion “c” forms an image with cyan toner (C). A fourth image forming portion “d” forms an image with black toner (Bk). Those four image forming portions are arranged in a row at constant intervals, and the configurations of the respective image forming portions are substantially the same in many respects except the color of the toner to be stored. Thus, the electrophotographic apparatus of this embodiment is described below through use of the first image forming portion “a”.

The first image forming portion “a” includes a photosensitive drum 1a, which is a drum-shaped photosensitive member, a charging roller 2a, which is a charging member, a developing unit 4a, and a drum cleaning unit 5a.

The photosensitive drum 1a is an image-bearing member that bears a toner image, and is rotationally driven in a direction indicated by the arrow R¹ illustrated in the figure at a predetermined peripheral speed (process speed). The developing unit 4a stores yellow toner and develops the yellow toner on the photosensitive drum 1a. The drum cleaning unit 5a is a unit for recovering the toner adhering to the photosensitive drum 1a. The drum cleaning unit 5a includes: a cleaning blade brought into contact with the photosensitive drum 1a; and a waste toner box that stores, for example, the toner removed from the photosensitive drum 1a by the cleaning blade.

An image forming operation is started when a control unit (not shown) such as a controller receives an image signal, and the photosensitive drum 1a is rotationally driven. During the rotation process, the photosensitive drum 1a is uniformly charged to a predetermined voltage (charging voltage) with predetermined polarity (negative polarity in this embodiment) by the charging roller 2a, and is exposed by an exposing unit 3a in accordance with the image signal. Thus, an electrostatic latent image corresponding to a yellow color component image of a target color image is formed on the photosensitive drum 1a. Then, the electrostatic latent image is developed by the developing unit 4a at a developing position and visualized as a yellow toner image on the photosensitive drum 1a. In this case, the normal charging polarity of the toner stored in the developing unit 4a is negative polarity, and the electrostatic latent image is subjected to reversal development with the toner charged to the same polarity as the charging polarity of the photosensitive drum 1a by the charging roller 2a. However, the present invention is not limited thereto, and the present invention may be applied even to an electrophotographic apparatus in which an electrostatic latent image is subjected to normal development with a toner charged to polarity opposite to the charging polarity of the photosensitive drum 1a.

An endless and movable intermediate transfer belt 10 has electroconductivity, is brought into contact with the photosensitive drum 1a to form a primary transfer portion N1a, and is rotated at substantially the same peripheral speed as that of the photosensitive drum 1a. In addition, the intermediate transfer belt 10 is tensioned by a counter roller 13 serving as a counter member, a drive roller 11 and a tension roller 12 each serving as a tension member, and a metal roller 14a, and is tensioned by the tension roller 12 under a tension of a total pressure of 60 N. The intermediate transfer belt 10 can be moved when the drive roller 11 is rotationally driven in a direction indicated by the arrow R² illustrated in the figure. In addition, the respective metal rollers 14 and the counter roller 13 are connected to a ground through a Zener diode 15 serving as a constant-voltage element.

The yellow toner image formed on the photosensitive drum 1a is primarily transferred from the photosensitive drum 1a to the intermediate transfer belt 10 in the process of passing through the primary transfer portion N1a. Primary transfer residual toner remaining on the surface of the photosensitive drum 1a is cleaned off and removed by the drum cleaning unit 5a, and is then subjected to an image forming process after charging.

During the primary transfer, a current is supplied to the electroconductive intermediate transfer belt 10 from a secondary transfer roller 20 serving as a secondary transfer member to be brought into contact with the outer peripheral surface of the intermediate transfer belt 10. When the current supplied from the secondary transfer roller 20 flows in the peripheral direction of the intermediate transfer belt 10, the toner image is primarily transferred from the photosensitive drum 1a to the intermediate transfer belt 10. In this case, a voltage having predetermined polarity (positive polarity in this embodiment) opposite to the normal charging polarity of the toner is applied to the secondary transfer roller 20 from a transfer power source 21.

Subsequently, a magenta toner image of the second color, a cyan toner image of the third color, and a black toner image of the fourth color are formed in the same manner, and are sequentially transferred onto the intermediate transfer belt 10 so as to be superimposed on one another. Thus, toner images of four colors corresponding to target color images are formed on the intermediate transfer belt 10. After that, the toner images of the four colors borne on the intermediate transfer belt 10 are secondarily transferred in a batch onto the surface of a transfer material P, such as paper or an OHP sheet, fed by a sheet feeding unit 50 in the process of passing through a secondary transfer portion N2 formed by the contact between the secondary transfer roller 20 and the intermediate transfer belt 10. The transfer material P having the toner images of the four colors transferred thereto by the secondary transfer is then heated and pressurized in a fixing unit 30, and thus the toners of the four colors are melted and mixed to be fixed to the transfer material P. The toner remaining on the intermediate transfer belt 10 after the secondary transfer is cleaned and removed by a belt cleaning unit 16 arranged so as to face the counter roller 13 through intermediation of the intermediate transfer belt 10. In addition, a path, which does not pass through the secondary transfer roller 20, and in which the transfer power source 21 and the respective metal rollers 14 are electrically connected to each other through a constant-current diode 22 serving as a constant-current element, is arranged. In addition, at the time of the application of the voltage from the transfer power source 21 to the secondary transfer roller 20, a pinch-off current Id flows through the constant-current diode 22 separately from a current It2 flowing toward the secondary transfer portion N2.

The electrophotographic photosensitive member of the present invention may be used in, for example, a laser beam printer, an LED printer, or a copying machine.

### EXAMPLES

The present invention is described in more detail below by way of Examples and Comparative Examples. The present invention is by no means limited to Examples described below without departing from the gist of the present invention.

In the following description of Examples, “part(s)” is by mass unless otherwise specified. In addition, the thicknesses of the respective layers of each of the electrophotographic photosensitive members of Examples and Comparative Examples except a surface layer and a charge-generating layer were determined by a method including using an eddy current-type thickness meter (Fischerscope, manufactured by Fischer Instruments K.K.), or a method including converting the mass of the layer per unit area into a specific gravity. The thickness of the charge-generating layer was measured by converting the Macbeth density value of the electrophotographic photosensitive member with a calibration curve obtained in advance from: a Macbeth density value measured by pressing a spectral densitometer (product name: X-Rite 504/508, manufactured by X-Rite, Inc.) against the surface of the electrophotographic photosensitive member; and the value of the thickness of the layer measured through the observation of a sectional SEM image thereof.

### <Production Example of Electrophotographic Photosensitive Member 1>

An aluminum cylinder having a diameter of 20 mm and a length of 257.5 mm (standard: JIS-A3003 aluminum alloy) was used as a support (electroconductive support).

An electroconductive layer, an undercoat layer, a charge-generating layer, a charge-transporting layer, and a surface layer were produced by the following methods.

### <Preparation of Coating Liquid for Electroconductive Layer>

Anatase-type titanium oxide having an average primary particle diameter of 200 nm was used as a substrate, and a sulfuric acid solution of titanium and niobium containing 33.7 parts of titanium in terms of TiO₂ and 2.9 parts of niobium in terms of Nb₂O₅ was prepared. 100 Parts of the substrate was dispersed in pure water to provide 1,000 parts of a suspension, and the suspension was warmed to 60° C. The sulfuric acid solution of titanium and niobium, and 10 mol/L sodium hydroxide were dropped over 3 hours so that the pH of the suspension became from 2 to 3. After the dropping of the total amounts of the solutions, the pH was adjusted to the vicinity of a neutral value, and a polyacrylamide-based aggregating agent was added to precipitate a solid content. The supernatant was removed, and the residue was filtered and washed, followed by drying at 110° C. Thus, an intermediate containing 0.1 wt % of organic matter derived from the aggregating agent in terms of C was obtained. The intermediate was fired in nitrogen at 750° C. for 1 hour, and was then fired in air at 450° C. to produce titanium oxide particle. The average primary particle diameter of the resultant particles measured by a method of measuring a particle diameter with a scanning electron microscope to be described later was 220 nm.

Subsequently, 50 parts of a phenol resin (monomer/oligomer of a phenol resin) (product name: PLYOPHEN J-325, manufacturer: DIC Corporation, resin solid content: 60%, density after curing: 1.3 g/cm³) serving as a binding material was dissolved in 35 parts of 1-methoxy-2-propanol serving as a solvent to provide a solution.

60 Parts of the titanium oxide particle 1 were added to the solution, and the mixture was loaded into a vertical sand mill using 120 parts of glass beads having a number-average primary particle diameter of 1.0 mm as a dispersion medium. After that, the mixture was subjected to dispersion treatment for 4 hours under the conditions of a dispersion liquid temperature of 23° C.±3° C. and a number of revolutions of 1,500 rpm (peripheral speed: 5.5 m/s). Thus, a dispersion liquid was obtained. The glass beads were removed from the dispersion liquid with a mesh. 0.01 Parts of a silicone oil (product name: SH28 PAINT ADDITIVE, manufacturer: Dow Corning Toray Co., Ltd.) serving as a leveling agent and 8 parts of a silicone resin particle (product name: KMP-590, manufacturer: Shin-Etsu Chemical Co., Ltd., average primary particle diameter: 2 μm, density: 1.3 g/cm³) serving as a surface roughness-imparting material were added to the dispersion liquid after the removal of the glass beads, and the mixture was stirred. After that, the mixture was filtered with PTFE filter paper (product name: PF-060, manufacturer: Advantec Toyo Kaisha, Ltd.) under pressure to prepare a coating liquid for an electroconductive layer.

### <Preparation of Coating Liquid for Undercoat Layer>

100 Parts of rutile-type titanium oxide particle (average primary particle diameter: 50 nm, manufacturer: Tayca Corporation) were stirred and mixed with 500 parts of toluene, and 3.5 parts of vinyltrimethoxysilane (product name: KBM-1003, manufacturer: Shin-Etsu Chemical Co., Ltd.) was added to the mixture, followed by dispersion treatment in a vertical sand mill using glass beads each having a diameter of 1.0 mm for 8 hours. After the glass beads had been removed, toluene was evaporated by distillation under reduced pressure, and the residue was dried for 3 hours at 120° C. to provide rutile-type titanium oxide particle whose surfaces had already been treated with an organosilicon compound. When the volume of the resultant titanium oxide particles was represented by “a”, and the average primary particle diameter of the titanium oxide particles was represented by “b” [μm], the ratio “a/b” was 15.6. The value of the “a” was determined from a microscopic image obtained by observing a section of an electrophotographic photosensitive member with a field emission scanning electron microscope (FE-SEM, product name: S-4800, manufacturer: Hitachi High-Technologies Corporation) after the production of the electrophotographic photosensitive member.

18.0 Parts of the rutile-type titanium oxide particle whose surfaces had already been treated with the organosilicon compound, 4.5 parts of N-methoxymethylated nylon (product name: TORESIN EF-30T, manufacturer: Nagase ChemteX Corporation), and 1.5 parts of a copolymerized nylon resin (product name: AMILAN CM8000, manufacturer: Toray Industries, Inc.) were added to a mixed solvent of 90 parts of methanol and 60 parts of 1-butanol to prepare a dispersion liquid.

The dispersion liquid was subjected to dispersion treatment in a vertical sand mill using glass beads each having a diameter of 1.0 mm for 5 hours, and the glass beads were removed. Thus, a coating liquid for an undercoat layer was prepared.

### <Synthesis of Phthalocyanine Pigment>

### <Synthesis Example>

Under a nitrogen flow atmosphere, 100 g of gallium trichloride and 291 g of orthophthalonitrile were added to 1,000 mL of α-chloronaphthalene, and the mixture was subjected to a reaction at a temperature of 200° C. for 24 hours, followed by the filtration of the product. The resultant wet cake was stirred in N,N-dimethylformamide under heating at a temperature of 150° C. for 30 minutes, and was then filtered. The resultant filter residue was washed with methanol, and was then dried to provide a chlorogallium phthalocyanine pigment in a yield of 83%.

20 Grams of the chlorogallium phthalocyanine pigment obtained by the above-mentioned method was dissolved in 500 mL of concentrated sulfuric acid, and the solution was stirred for 2 hours. After that, the solution was dropped into a mixed solution of 1,700 mL of distilled water and 660 mL of concentrated ammonia water, which had been cooled with ice, so that the pigment was reprecipitated. The precipitate was sufficiently washed with distilled water, and was dried to provide a hydroxygallium phthalocyanine pigment.

### <Preparation of Coating Liquid for Charge-Generating Layer>

0.5 Parts of the hydroxygallium phthalocyanine pigment obtained in Synthesis Example, 7.5 parts of N,N-dimethylformamide (product code: D0722, manufacturer: Tokyo Chemical Industry Co., Ltd.), and 29 parts of glass beads each having a diameter of 0.9 mm were subjected to milling treatment with a sand mill (product name: BSG-20, manufacturer: AIMEX Co., Ltd.) under a temperature of 25° C. for 24 hours. At this time, the treatment was performed under such a condition that the disc of the sand mill rotated 1,500 times in 1 minute. The liquid thus treated was filtered with a filter (product number: N-NO. 125T, pore diameter: 133 μm, manufacturer: NBC Meshtec Inc.) so that the glass beads were removed. 30 Parts of N,N-dimethylformamide was added to the liquid, and then the mixture was filtered, followed by sufficient washing of the filter residue on a filter with n-butyl acetate. Then, the washed filter residue was dried in a vacuum to provide 0.45 parts of a hydroxygallium phthalocyanine pigment. The resultant pigment contained N,N-dimethylformamide.

Subsequently, 20 parts of the hydroxygallium phthalocyanine pigment obtained by the milling treatment, 10 parts of polyvinyl butyral (product name: S-LEC BX-1, manufacturer: Sekisui Chemical Co., Ltd.), 190 parts of cyclohexanone, and 482 parts of glass beads each having a diameter of 0.9 mm were subjected to dispersion treatment with a sand mill (product name: K-800, manufacturer: Igarashi Machine Production Co., Ltd. (currently AIMEX Co., Ltd.), disc diameter: 70 mm, number of discs: 5) under a cooling water temperature of 18° C. for 4 hours. At this time, the treatment was performed under such a condition that the discs each rotated 1,800 times in 1 minute. The glass beads were removed from the dispersion liquid, and 444 parts of cyclohexanone and 634 parts of ethyl acetate were added to the residue to prepare a coating liquid for a charge-generating layer.

### <Preparation of Coating Liquid for Charge-Transporting Layer>

### (Production Example of Charge-Transporting Layer)

Next, the following materials were prepared to produce a mixed solvent.

| | |
|---|---|
| Orthoxylene | 25 parts by mass |
| Methyl benzoate | 25 parts by mass |
| Dimethoxymethane | 25 parts by mass |

Further, the following materials were dissolved in the mixed solvent to prepare a coating liquid for a charge-transporting layer.

| | | |
|---|---|---|
| Charge-transporting material (hole-transportable | 5 | parts by mass |
| material) represented by the following structural | | |
| formula (C-1) | | |
| Charge-transporting material (hole-transportable | 5 | parts by mass |
| material) represented by the following structural | | |
| formula (C-2) | | |
| Polycarbonate (product name: IUPILON Z-400, | 10 | parts by mass |
| manufacturer: Mitsubishi Engineering-Plastics | | |
| Corporation) | | |

The coating liquid 1 for a charge-transporting layer was applied onto the charge-generating layer 1 by dip coating to form a coat, and the coat was dried at a drying temperature of 40° C. for 5 minutes to form a charge-transporting layer 1 having a thickness of 15 μm.

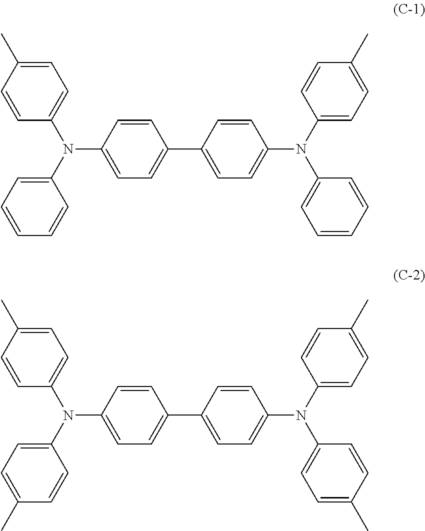 [SMILES: Cc1ccc(N(c2ccccc2)c2ccc(-c3ccc(N(c4ccccc4)c4ccc(C)cc4)cc3)cc2)cc1 ; Cc1ccc(N(c2ccc(C)cc2)c2ccc(-c3ccc(N(c4ccc(C)cc4)c4ccc(C)cc4)cc3)cc2)cc1]

### <Production Example of Electrophotographic Photosensitive Member 1><Support>

An aluminum cylinder having a diameter of 20 mm and a length of 257.5 mm (standard: JIS-A3003, aluminum alloy) was used as a support (electroconductive support).

### <Electroconductive Layer>

The coating liquid for an electroconductive layer was applied onto the above-mentioned support by dip coating to form a coat, and the coat was heated at 150° C. for 30 minutes to be cured. Thus, an electroconductive layer having a thickness of 22 μm was formed.

### <Undercoat Layer>

The coating liquid for an undercoat layer was applied onto the above-mentioned electroconductive layer by dip coating to form a coat, and the coat was heated at 100° C. for 10 minutes to be cured. Thus, an undercoat layer having a thickness of 1.8 μm was formed.

### <Charge-Generating Layer>

The coating liquid for a charge-generating layer was applied onto the above-mentioned undercoat layer by dip coating to form a coat, and the coat was dried by heating at a temperature of 100° C. for 10 minutes. Thus, a charge-generating layer having a thickness of 0.20 μm was formed.

### <Charge-Transporting Layer>

The coating liquid for a charge-transporting layer was applied onto the above-mentioned charge-generating layer by dip coating to form a coat, and the coat was dried by heating at a temperature of 120° C. for 30 minutes. Thus, a charge-transporting layer having a thickness of 21 μm was formed.

### <Surface Layer>

| | | |
|---|---|---|
| Acrylic monomer (product name: TPOA-50, | 3.90 | parts by mass |
| manufacturer: Shin-Nakamura Chemical Co., | | |
| Ltd.) | | |
| Inorganic particle (product name: QSG-170, | 11.7 | parts by mass |
| manufacturer: Shin-Etsu Chemical Co., Ltd.) | | |
| Cyclohexane | 100 | parts by mass |
| 1-Propanol | 100 | parts by mass |

The above-mentioned materials were mixed and stirred to prepare a coating liquid 1 for a surface layer.

The coating liquid 1 for a surface layer was applied onto the charge-transporting layer by dip coating to form a coat, and the resultant coat was dried at 40° C. for 5 minutes.

After that, the coat was irradiated with an electron beam while the support (body to be irradiated) was rotated at a speed of 300 rpm under a nitrogen atmosphere under the following conditions.

Acceleration voltage: 70 kV

Beam current: 5.0 mA

Electron beam irradiation time: 1.6 seconds

The radiation dose at the position of the surface layer was 15 kGy. After that, first heating was performed by raising the temperature from 25° C. to 100° C. over 20 seconds under a nitrogen atmosphere to form a surface layer having a thickness of 1.0 μm. The concentration of oxygen from the irradiation with an electron beam to the subsequent heating treatment was 10 ppm or less. Next, the resultant was naturally cooled in the atmosphere until the temperature of the coat reached 25° C., and second heating treatment was performed for 20 minutes under such a condition that the temperature of the coat reached 135° C. Thus, an electrophotographic photosensitive member 1 was produced.

### <Production Examples of Electrophotographic Photosensitive Members 2 to 31>

In the production example of the electrophotographic photosensitive member 1, the process up to the production of the charge-transporting layer was similarly performed, and coating liquids 2 to 31 for surface layers to be used in the production of surface layers were prepared while materials therefor were changed as shown in Table 1 (Table 1-1 to Table 1-4). Electrophotographic photosensitive members 2 to 31 were produced by the same method as that of the electrophotographic photosensitive member 1 through use of the prepared coating liquids 2 to 31 for surface layers, respectively.

Here, the term “Volume ratio of the inorganic particle to binder resin” shown in Table 1 indicates the value of a ratio of the total volume of the inorganic particle A and the inorganic particle B to the total volume of binder resin A and binder resin B. In addition, the term “Molecular weight of monomer” shown in Table 1 indicates the molecular weight of a polymerizable monomer having the largest number of polymerizable functional groups in the composition contained in the binder resin.

TABLE 1-1

| | Binder resin A | | | Binder resin B | | |
|---|---|---|---|---|---|---|
| Kind of coating | | Largest number | | | Largest number | |
| liquid for | Product | of functional | Part(s) | Product | of functional | Part(s) |
| surface layer | name | groups | by mass | name | groups | by mass |
| Coating liquid 1 | TPOA-50 | 8 | 3.90 | — | — | — |
| for surface layer | | | | | | |
| Coating liquid 2 | TPOA-50 | 8 | 3.90 | — | — | — |
| for surface layer | | | | | | |
| Coating liquid 3 | TPOA-50 | 8 | 3.90 | — | — | — |
| for surface layer | | | | | | |
| Coating liquid 4 | DPHA | 6 | 3.90 | — | — | — |
| for surface layer | | | | | | |
| Coating liquid 5 | DPHA | 6 | 3.90 | — | — | — |
| for surface layer | | | | | | |
| Coating liquid 6 | DPHA | 6 | 3.90 | — | — | — |
| for surface layer | | | | | | |
| Coating liquid 7 | EBECRYL 1290 | 6 | 3.90 | — | — | — |
| for surface layer | | | | | | |
| Coating liquid 8 | EBECRYL 1290 | 6 | 3.90 | — | — | — |
| for surface layer | | | | | | |
| Coating liquid 9 | EBECRYL 1290 | 6 | 3.90 | — | — | — |
| for surface layer | | | | | | |
| Coating liquid 10 | A9550 | 6 | 3.90 | — | — | — |
| for surface layer | | | | | | |
| Coating liquid 11 | DPHA | 6 | 2.36 | PETA | 4 | 1.54 |
| for surface layer | | | | | | |
| Coating liquid 12 | DPHA | 6 | 2.36 | PETA | 4 | 1.54 |
| for surface layer | | | | | | |
| Coating liquid 13 | DPHA | 6 | 2.36 | PETA | 4 | 1.54 |
| for surface layer | | | | | | |
| Coating liquid 14 | TPOA-50 | 8 | 3.90 | — | — | — |
| for surface layer | | | | | | |
| Coating liquid 15 | TPOA-50 | 8 | 3.90 | — | — | — |
| for surface layer | | | | | | |
| Coating liquid 16 | TPOA-50 | 8 | 3.90 | — | — | — |
| for surface layer | | | | | | |
| Coating liquid 17 | TPOA-50 | 8 | 3.90 | — | — | — |
| for surface layer | | | | | | |
| Coating liquid 18 | DPHA | 6 | 2.36 | PETA | 4 | 1.54 |
| for surface layer | | | | | | |
| Coating liquid 19 | TPOA-50 | 8 | 3.90 | — | — | — |
| for surface layer | | | | | | |
| Coating liquid 20 | TPOA-50 | 8 | 3.90 | — | — | — |
| for surface layer | | | | | | |
| Coating liquid 21 | TPOA-50 | 8 | 3.90 | — | — | — |
| for surface layer | | | | | | |
| Coating liquid 22 | TPOA-50 | 8 | 3.90 | — | — | — |
| for surface layer | | | | | | |
| Coating liquid 23 | TPOA-50 | 8 | 3.90 | — | — | — |
| for surface layer | | | | | | |
| Coating liquid 24 | DPHA | 6 | 3.55 | Behenyl acrylate | 1 | 0.36 |
| for surface layer | | | | | | |
| Coating liquid 25 | DPHA | 6 | 3.55 | Stearyl acrylate | 1 | 0.36 |
| for surface layer | | | | | | |
| Coating liquid 26 | DPHA | 6 | 3.55 | Myristyl acrylate | 1 | 0.36 |
| for surface layer | | | | | | |
| Coating liquid 27 | DPHA | 6 | 3.55 | Lauryl acrylate | 1 | 0.36 |
| for surface layer | | | | | | |
| Coating liquid 28 | DPHA | 6 | 3.55 | 2-ethylhexyl | 1 | 0.36 |
| for surface layer | | | | acrylate | | |
| Coating liquid 29 | TPOA-50 | 8 | 3.90 | — | — | — |
| for surface layer | | | | | | |
| Coating liquid 30 | TPOA-50 | 8 | 3.90 | — | — | — |
| for surface layer | | | | | | |
| Coating liquid 31 | TPOA-50 | 8 | 3.90 | — | — | — |
| for surface layer | | | | | | |

TABLE 1-2

| | Inorganic particle A | | | Inorganic particle B | | |
|---|---|---|---|---|---|---|
| | | Average | | | Average | |
| Kind of coating | | particle | | | particle | |
| liquid for | Product | diameter DA | Part(s) | Product | diameter DB | Part(s) |
| surface layer | name | [nm] | by mass | name | [nm] | by mass |
| Coating liquid 1 | QSG-170 | 170 | 11.7 | — | — | — |
| for surface layer | | | | | | |
| Coating liquid 2 | QSG-170 | 170 | 23.4 | — | — | — |
| for surface layer | | | | | | |
| Coating liquid 3 | QSG-170 | 170 | 5.90 | — | — | — |
| for surface layer | | | | | | |
| Coating liquid 4 | QSG-170 | 170 | 11.7 | — | — | — |
| for surface layer | | | | | | |
| Coating liquid 5 | QSG-170 | 170 | 23.4 | — | — | — |
| for surface layer | | | | | | |
| Coating liquid 6 | QSG-170 | 170 | 5.90 | — | — | — |
| for surface layer | | | | | | |
| Coating liquid 7 | QSG-170 | 170 | 11.7 | — | — | — |
| for surface layer | | | | | | |
| Coating liquid 8 | QSG-170 | 170 | 23.4 | — | — | — |
| for surface layer | | | | | | |
| Coating liquid 9 | QSG-170 | 170 | 5.90 | — | — | — |
| for surface layer | | | | | | |
| Coating liquid 10 | QSG-170 | 170 | 11.7 | — | — | — |
| for surface layer | | | | | | |
| Coating liquid 11 | QSG-170 | 170 | 11.7 | — | — | — |
| for surface layer | | | | | | |
| Coating liquid 12 | QSG-170 | 170 | 23.4 | — | — | — |
| for surface layer | | | | | | |
| Coating liquid 13 | QSG-170 | 170 | 5.90 | — | — | — |
| for surface layer | | | | | | |
| Coating liquid 14 | QSG-100 | 110 | 11.7 | — | — | — |
| for surface layer | | | | | | |
| Coating liquid 15 | QSG-100 | 110 | 23.4 | — | — | — |
| for surface layer | | | | | | |
| Coating liquid 16 | QSG-100 | 110 | 5.90 | — | — | — |
| for surface layer | | | | | | |
| Coating liquid 17 | QSG-100 | 110 | 5.90 | — | — | — |
| for surface layer | | | | | | |
| Coating liquid 18 | QSG-170 | 170 | 5.90 | — | — | — |
| for surface layer | | | | | | |
| Coating liquid 19 | KE-P30 | 300 | 11.7 | — | — | — |
| for surface layer | | | | | | |
| Coating liquid 20 | KE-P30 | 300 | 23.4 | — | — | — |
| for surface layer | | | | | | |
| Coating liquid 21 | KE-P30 | 300 | 5.90 | — | — | — |
| for surface layer | | | | | | |
| Coating liquid 22 | KE-P10 | 100 | 5.60 | QSG-80 | 80 | 5.60 |
| for surface layer | | | | | | |
| Coating liquid 23 | KE-P30 | 300 | 5.60 | QSG-80 | 80 | 5.60 |
| for surface layer | | | | | | |
| Coating liquid 24 | QSG-170 | 170 | 11.7 | — | — | — |
| for surface layer | | | | | | |
| Coating liquid 25 | QSG-170 | 170 | 11.7 | — | — | — |
| for surface layer | | | | | | |
| Coating liquid 26 | QSG-170 | 170 | 11.7 | — | — | — |
| for surface layer | | | | | | |
| Coating liquid 27 | QSG-170 | 170 | 11.7 | — | — | — |
| for surface layer | | | | | | |
| Coating liquid 28 | QSG-170 | 170 | 11.7 | — | — | — |
| for surface layer | | | | | | |
| Coating liquid 29 | ZnO-S05 | 224 | 36.4 | — | — | — |
| for surface layer | | | | | | |
| Coating liquid 30 | JR-405 | 210 | 26.0 | — | — | — |
| for surface layer | | | | | | |
| Coating liquid 31 | QSG-170 | 170 | 1.40 | ZnO-S05 | 224 | 17.0 |
| for surface layer | | | | | | |

TABLE 1-3

| | Solvent A | | Solvent B | |
|---|---|---|---|---|
| Kind of coating liquid for | | Part(s) | | Part(s) |
| surface layer | Kind | by mass | Kind | by mass |
| Coating liquid 1 for surface layer | Cyclohexanone | 100 | 1-Propanol | 100 |
| Coating liquid 2 for surface layer | Cyclohexanone | 100 | 1-Propanol | 100 |
| Coating liquid 3 for surface layer | Cyclohexanone | 100 | 1-Propanol | 100 |
| Coating liquid 4 for surface layer | Cyclohexanone | 100 | 1-Propanol | 100 |
| Coating liquid 5 for surface layer | Cyclohexanone | 100 | 1-Propanol | 100 |
| Coating liquid 6 for surface layer | Cyclohexanone | 100 | 1-Propanol | 100 |
| Coating liquid 7 for surface layer | Cyclohexanone | 100 | 1-Propanol | 100 |
| Coating liquid 8 for surface layer | Cyclohexanone | 100 | 1-Propanol | 100 |
| Coating liquid 9 for surface layer | Cyclohexanone | 100 | 1-Propanol | 100 |
| Coating liquid 10 for surface layer | Cyclohexanone | 100 | 1-Propanol | 100 |
| Coating liquid 11 for surface layer | Cyclohexanone | 100 | 1-Propanol | 100 |
| Coating liquid 12 for surface layer | Cyclohexanone | 100 | 1-Propanol | 100 |
| Coating liquid 13 for surface layer | Cyclohexanone | 100 | 1-Propanol | 100 |
| Coating liquid 14 for surface layer | Cyclohexanone | 100 | 1-Propanol | 100 |
| Coating liquid 15 for surface layer | Cyclohexanone | 100 | 1-Propanol | 100 |
| Coating liquid 16 for surface layer | Cyclohexanone | 100 | 1-Propanol | 100 |
| Coating liquid 17 for surface layer | Cyclohexanone | 100 | 1-Propanol | 100 |
| Coating liquid 18 for surface layer | Cyclohexanone | 100 | 1-Propanol | 100 |
| Coating liquid 19 for surface layer | Cyclohexanone | 100 | 1-Propanol | 100 |
| Coating liquid 20 for surface layer | Cyclohexanone | 100 | 1-Propanol | 100 |
| Coating liquid 21 for surface layer | Cyclohexanone | 100 | 1-Propanol | 100 |
| Coating liquid 22 for surface layer | Cyclohexanone | 100 | 1-Propanol | 100 |
| Coating liquid 23 for surface layer | Cyclohexanone | 100 | 1-Propanol | 100 |
| Coating liquid 24 for surface layer | Cyclohexanone | 100 | 1-Propanol | 100 |
| Coating liquid 25 for surface layer | Cyclohexanone | 100 | 2-Propanol | 100 |
| Coating liquid 26 for surface layer | Cyclohexanone | 100 | 3-Propanol | 100 |
| Coating liquid 27 for surface layer | Cyclohexanone | 100 | 4-Propanol | 100 |
| Coating liquid 28 for surface layer | Cyclohexanone | 100 | 5-Propanol | 100 |
| Coating liquid 29 for surface layer | Cyclohexanone | 100 | 1-Propanol | 100 |
| Coating liquid 30 for surface layer | Cyclohexanone | 100 | 1-Propanol | 100 |
| Coating liquid 31 for surface layer | Cyclohexanone | 100 | 1-Propanol | 100 |

TABLE 1-4

| | Volume ratio of | Molecular | Content ratio of (meth)acrylic monomer |
|---|---|---|---|
| Kind of coating liquid for | inorganic particle | weight of | having 6 or more polymerizable |
| surface layer | to binder resin | monomer | functional groups [%] |
| Coating liquid 1 for surface layer | 2.0 | 804 | 81 |
| Coating liquid 2 for surface layer | 4.0 | 804 | 81 |
| Coating liquid 3 for surface layer | 1.0 | 804 | 81 |
| Coating liquid 4 for surface layer | 2.0 | 578 | 66 |
| Coating liquid 5 for surface layer | 4.0 | 578 | 66 |
| Coating liquid 6 for surface layer | 1.0 | 578 | 66 |
| Coating liquid 7 for surface layer | 2.0 | 1,030 | 92 |
| Coating liquid 8 for surface layer | 4.0 | 1,030 | 92 |
| Coating liquid 9 for surface layer | 1.0 | 1,030 | 92 |
| Coating liquid 10 for surface layer | 2.0 | 578 | 51 |
| Coating liquid 11 for surface layer | 2.0 | 578 | 40 |
| Coating liquid 12 for surface layer | 4.0 | 578 | 40 |
| Coating liquid 13 for surface layer | 1.0 | 578 | 40 |
| Coating liquid 14 for surface layer | 2.0 | 804 | 81 |
| Coating liquid 15 for surface layer | 4.0 | 804 | 81 |
| Coating liquid 16 for surface layer | 1.0 | 804 | 81 |
| Coating liquid 17 for surface layer | 1.0 | 804 | 81 |
| Coating liquid 18 for surface layer | 1.0 | 578 | 40 |
| Coating liquid 19 for surface layer | 2.0 | 804 | 81 |
| Coating liquid 20 for surface layer | 4.0 | 804 | 81 |
| Coating liquid 21 for surface layer | 1.0 | 804 | 81 |
| Coating liquid 22 for surface layer | 2.0 | 804 | 81 |
| Coating liquid 23 for surface layer | 2.0 | 804 | 81 |
| Coating liquid 24 for surface layer | 2.0 | 578 | 60 |
| Coating liquid 25 for surface layer | 2.0 | 578 | 60 |
| Coating liquid 26 for surface layer | 2.0 | 578 | 60 |
| Coating liquid 27 for surface layer | 2.0 | 578 | 60 |
| Coating liquid 28 for surface layer | 2.0 | 578 | 60 |
| Coating liquid 29 for surface layer | 2.0 | 804 | 81 |
| Coating liquid 30 for surface layer | 2.0 | 804 | 81 |
| Coating liquid 31 for surface layer | 2.0 | 804 | 81 |

TPOA-50 (manufacturer: Shin-Nakamura Chemical Co., Ltd.)

DPHA (manufacturer: Daicel-Allnex Ltd.)

EBECRYL 1290 (manufacturer: Daicel-Allnex Ltd.)

A9550 (manufacturer: Shin-Nakamura Chemical Co., Ltd.)

PETA (manufacturer: Daicel-Allnex Ltd.)

Behenyl acrylate (manufacturer: Tokyo Chemical Industry Co., Ltd.)

Stearyl acrylate (manufacturer: Tokyo Chemical Industry Co., Ltd.)

Myristyl acrylate (manufacturer: Tokyo Chemical Industry Co., Ltd.)

Lauryl acrylate (manufacturer: Tokyo Chemical Industry Co., Ltd.)

2-Ethylhexyl acrylate (manufacturer: Tokyo Chemical Industry Co., Ltd.)

QSG-170 (manufacturer: Shin-Etsu Chemical Co., Ltd.)

QSG-100 (manufacturer: Shin-Etsu Chemical Co., Ltd.)

KE-P30 (manufacturer: Nippon Shokubai Co., Ltd.)

KE-P10 (manufacturer: Nippon Shokubai Co., Ltd.)

ZnO-S05 (manufacturer: Sumitomo Osaka Cement Co., Ltd.)

JR-405 (manufacturer: Tayca Corporation)

For the densities and specific gravities of a polymerization product obtained after the polymerization of the polymerizable monomer having a polymerizable functional group and the particles, reference may be made to values published in the manufacturers of the respective materials and the database “POLYINFO” of National Institute for Materials Science. The following values were used as the specific gravities of various materials.

Density of polymerization product of (meth)acrylic monomer: 1.2 g/cm³

Density of silica particle: 1.8 g/cm³

Density of zinc oxide: 5.6 g/cm³

Density of titanium oxide: 4.0 g/cm³

### COMPARATIVE EXAMPLES

In the production example of the electrophotographic photosensitive member 1, the process up to the production of the charge-transporting layer was similarly performed, and coating liquids c1 to c18 for surface layers to be used in the production of surface layers were prepared while materials therefor were changed as shown in Table 2 (Table 2-1 to Table 2-4). Electrophotographic photosensitive members c1 to c18 were produced by the same method as that of the electrophotographic photosensitive member 1 through use of the prepared coating liquids c1 to c18 for surface layers, respectively.

TABLE 2-1

| | Binder resin A | | | Binder resin B | | |
|---|---|---|---|---|---|---|
| Kind of coating | | Largest number | | | Largest number | |
| liquid for | Product | of functional | Part(s) | Product | of functional | Part(s) |
| surface layer | name | groups | by mass | name | groups | by mass |
| Coating liquid c1 | DPHA | 6 | 3.90 | — | — | — |
| for surface layer | | | | | | |
| Coating liquid c2 | DPHA | 6 | 3.90 | — | — | — |
| for surface layer | | | | | | |
| Coating liquid c3 | TPOA-50 | 8 | 3.90 | — | — | — |
| for surface layer | | | | | | |
| Coating liquid c4 | TPOA-50 | 8 | 3.90 | — | — | — |
| for surface layer | | | | | | |
| Coating liquid c5 | EBECRYL | 4 | 3.90 | — | — | — |
| for surface layer | 1142 | | | | | |
| Coating liquid c6 | EBECRYL | 4 | 3.90 | — | — | — |
| for surface layer | 1142 | | | | | |
| Coating liquid c7 | EBECRYL | 6 | 3.90 | — | — | — |
| for surface layer | 1290 | | | | | |
| Coating liquid c8 | EBECRYL | 6 | 3.90 | — | — | — |
| for surface layer | 1290 | | | | | |
| Coating liquid c9 | DPHA | 6 | 2.44 | PETA | 4 | 1.46 |
| for surface layer | | | | | | |
| Coating liquid c10 | DPHA | 6 | 2.44 | PETA | 4 | 1.46 |
| for surface layer | | | | | | |
| Coating liquid c11 | TPOA-50 | 8 | 3.90 | — | — | — |
| for surface layer | | | | | | |
| Coating liquid c12 | TPOA-50 | 8 | 3.90 | — | — | — |
| for surface layer | | | | | | |
| Coating liquid c13 | TPOA-50 | 8 | 3.90 | — | — | — |
| for surface layer | | | | | | |
| Coating liquid c14 | TPOA-50 | 8 | 3.90 | — | — | — |
| for surface layer | | | | | | |
| Coating liquid c15 | TPOA-50 | 8 | 3.90 | — | — | — |
| for surface layer | | | | | | |
| Coating liquid c16 | TPOA-50 | 8 | 3.90 | — | — | — |
| for surface layer | | | | | | |
| Coating liquid c17 | DPHA | 6 | 2.17 | PETA | 4 | 1.73 |
| for surface layer | | | | | | |
| Coating liquid c18 | DPHA | 6 | 2.17 | PETA | 4 | 1.73 |
| for surface layer | | | | | | |

TABLE 2-2

| | Inorganic particle A | | | Inorganic particle B | | |
|---|---|---|---|---|---|---|
| | | Average | | | Average | |
| Kind of coating | | particle | | | particle | |
| liquid for | Product | diameter | Part(s) | Product | diameter | Part(s) |
| surface layer | name | DA[nm] | by mass | name | DB[nm] | by mass |
| Coating liquid c1 for | QSG-170 | 170 | 4.70 | — | — | — |
| surface layer | | | | | | |
| Coating liquid c2 for | QSG-170 | 170 | 29.3 | — | — | — |
| surface layer | | | | | | |
| Coating liquid c3 for | QSG-170 | 170 | 4.70 | — | — | — |
| surface layer | | | | | | |
| Coating liquid c4 for | QSG-170 | 170 | 29.3 | — | — | — |
| surface layer | | | | | | |
| Coating liquid c5 for | QSG-170 | 170 | 5.90 | — | — | — |
| surface layer | | | | | | |
| Coating liquid c6 for | QSG-170 | 170 | 23.4 | — | — | — |
| surface layer | | | | | | |
| Coating liquid c7 for | QSG-170 | 170 | 4.70 | — | — | — |
| surface layer | | | | | | |
| Coating liquid c8 for | QSG-170 | 170 | 29.3 | — | — | — |
| surface layer | | | | | | |
| Coating liquid c9 for | QSG-170 | 170 | 4.70 | — | — | — |
| surface layer | | | | | | |
| Coating liquid c10 for | QSG-170 | 170 | 29.3 | — | — | — |
| surface layer | | | | | | |
| Coating liquid c11 for | QSG-100 | 110 | 4.70 | — | — | — |
| surface layer | | | | | | |
| Coating liquid c12 for | QSG-100 | 110 | 29.3 | — | — | — |
| surface layer | | | | | | |
| Coating liquid c13 for | QSG-30 | 30 | 5.90 | — | — | — |
| surface layer | | | | | | |
| Coating liquid c14 for | QSG-30 | 30 | 23.4 | — | — | — |
| surface layer | | | | | | |
| Coating liquid c15 for | KE-P50 | 500 | 5.90 | — | — | — |
| surface layer | | | | | | |
| Coating liquid c16 for | KE-P50 | 500 | 23.4 | — | — | — |
| surface layer | | | | | | |
| Coating liquid c17 for | QSG-170 | 170 | 5.90 | — | — | — |
| surface layer | | | | | | |
| Coating liquid c18 for | QSG-170 | 170 | 23.4 | — | — | — |
| surface layer | | | | | | |

TABLE 2-3

| | Solvent A | | Solvent B | |
|---|---|---|---|---|
| Kind of coating liquid | | Part(s) | | Part(s) |
| for surface layer | Kind | by mass | Kind | by mass |
| Coating liquid c1 for | Cyclohexanone | 100 | 1-Propanol | 100 |
| surface layer | | | | |
| Coating liquid c2 for | Cyclohexanone | 100 | 1-Propanol | 100 |
| surface layer | | | | |
| Coating liquid c3 for | Cyclohexanone | 100 | 1-Propanol | 100 |
| surface layer | | | | |
| Coating liquid c4 for | Cyclohexanone | 100 | 1-Propanol | 100 |
| surface layer | | | | |
| Coating liquid c5 for | Cyclohexanone | 100 | 1-Propanol | 100 |
| surface layer | | | | |
| Coating liquid c6 for | Cyclohexanone | 100 | 1-Propanol | 100 |
| surface layer | | | | |
| Coating liquid c7 for | Cyclohexanone | 100 | 1-Propanol | 100 |
| surface layer | | | | |
| Coating liquid c8 for | Cyclohexanone | 100 | 1-Propanol | 100 |
| surface layer | | | | |
| Coating liquid c9 for | Cyclohexanone | 100 | 1-Propanol | 100 |
| surface layer | | | | |
| Coating liquid c10 for | Cyclohexanone | 100 | 1-Propanol | 100 |
| surface layer | | | | |
| Coating liquid c11 for | Cyclohexanone | 100 | 1-Propanol | 100 |
| surface layer | | | | |
| Coating liquid c 12 for | Cyclohexanone | 100 | 1-Propanol | 100 |
| surface layer | | | | |
| Coating liquid c13 for | Cyclohexanone | 100 | 1-Propanol | 100 |
| surface layer | | | | |
| Coating liquid c14 for | Cyclohexanone | 100 | 1-Propanol | 100 |
| surface layer | | | | |
| Coating liquid c15 for | Cyclohexanone | 100 | 1-Propanol | 100 |
| surface layer | | | | |
| Coating liquid c16 for | Cyclohexanone | 100 | 1-Propanol | 100 |
| surface layer | | | | |
| Coating liquid c17 for | Cyclohexanone | 100 | 1-Propanol | 100 |
| surface layer | | | | |
| Coating liquid c18 for | Cyclohexanone | 100 | 1-Propanol | 100 |
| surface layer | | | | |

TABLE 2-4

| | | | Content ratio of |
|---|---|---|---|
| | Volume of | | (meth)acrylic monomer |
| Kind of coating | inorganic | Molecular | having 6 or more |
| liquid for | particle to | weight of | polymerizable |
| surface layer | binder resin | monomer | functional groups [%] |
| Coating liquid c1 | 0.8 | 578 | 66 |
| for surface layer | | | |
| Coating liquid c2 | 5.0 | 578 | 66 |
| for surface layer | | | |
| Coating liquid c3 | 0.8 | 804 | 80 |
| for surface layer | | | |
| Coating liquid c4 | 5.0 | 804 | 80 |
| for surface layer | | | |
| Coating liquid c5 | 1.0 | 466 | 0 |
| for surface layer | | | |
| Coating liquid c6 | 4.0 | 466 | 0 |
| for surface layer | | | |
| Coating liquid c7 | 0.8 | 1,030 | 95 |
| for surface layer | | | |
| Coating liquid c8 | 5.0 | 1,030 | 95 |
| for surface layer | | | |
| Coating liquid c9 | 0.8 | 578 | 41 |
| for surface layer | | | |
| Coating liquid c10 | 5.0 | 578 | 41 |
| for surface layer | | | |
| Coating liquid c11 | 0.8 | 804 | 80 |
| for surface layer | | | |
| Coating liquid c12 | 5.0 | 804 | 80 |
| for surface layer | | | |
| Coating liquid c13 | 1.0 | 804 | 80 |
| for surface layer | | | |
| Coating liquid c14 | 4.0 | 804 | 80 |
| for surface layer | | | |
| Coating liquid c15 | 1.0 | 804 | 80 |
| for surface layer | | | |
| Coating liquid c16 | 4.0 | 804 | 80 |
| for surface layer | | | |
| Coating liquid c17 | 1.0 | 578 | 37 |
| for surface layer | | | |
| Coating liquid c18 | 4.0 | 578 | 37 |
| for surface layer | | | |

EBECRYL 1142 (manufacturer: Daicel-Allnex Ltd.)

QSG-30 (manufacturer: Daicel-Allnex Ltd.)

KE-P50 (manufacturer: Nippon Shokubai Co., Ltd.)

### <Evaluation Approach>

### <Derivation of Ratio of Volume of Inorganic Particle to Volume of Binder Resin in Surface Layer>

The ratio of the volume of the inorganic particle to the volume of a binder resin in a surface layer was calculated from the prepared numbers of parts of an acrylic monomer and the inorganic particle to be used in a coating liquid for a surface layer. For the specific gravities of the acrylic monomer and the inorganic particle, reference may be made to values published in the manufacturers of the respective materials.

When the ratio is determined from an electrophotographic photosensitive member, for example, the following method is available.

A plurality of sections are peeled only from the surface layer of the electrophotographic photosensitive member with a cutting tool, and the sections are each subjected to composition analysis, such as NMR, ESI-MS, or LC-CAD/MS/MSn, so that a polymerizable monomer having a polymerizable functional group, the monomer forming a composition before the binder resin in the surface layer becomes a polymer, may be identified.

In addition, another section is subjected to thermogravimetric analysis such as TGA so that the masses of the binder resin and the inorganic particle incorporated into the surface layer may be measured.

Further, sintered inorganic particles are subjected to composition analysis, such as SEM-EDS or XRF, so that a material for the inorganic particle may be identified, followed by the determination of its specific gravity.

In the electrophotographic photosensitive member including the surface layer containing the binder resin and the inorganic particle, the value of the ratio of the volume of the inorganic particle to the volume of the binder resin in the surface layer is calculated by the foregoing.

### <Derivation of Number of Polymerizable Functional Groups of Polymerizable Monomer>

For the number of polymerizable functional groups of a polymerizable monomer, reference was made to information published in the manufacturers of the materials for an acrylic monomer to be used in a coating liquid for a surface layer.

When the ratio is determined from an electrophotographic photosensitive member, for example, the following method is available. A plurality of sections are peeled only from the surface layer of the electrophotographic photosensitive member with a cutting tool, and the sections are each subjected to composition analysis, such as NMR, ESI-MS, or LC-CAD/MS/MSn, so that a polymerizable monomer having a polymerizable functional group, the monomer forming a composition before the binder resin in the surface layer becomes a polymer, may be identified. Thus, the number of polymerizable functional groups of the polymerizable monomer is derived.

### <Derivation of Molecular Weight of (Meth)acrylic Monomer Having 6 or More Polymerizable Functional Groups>

For the number of polymerizable functional groups of a polymerizable monomer, reference was made to information published in the manufacturers of the materials.

When the ratio is determined from an electrophotographic photosensitive member, for example, the following method is available. A plurality of sections are peeled only from the surface layer of the electrophotographic photosensitive member with a cutting tool, and the sections are each subjected to composition analysis, such as NMR, ESI-MS, or LC-CAD/MS/MSn, so that a polymerizable monomer having a polymerizable functional group, the monomer forming a composition before the binder resin in the surface layer becomes a polymer, may be identified. Thus, the molecular weight of the (meth)acrylic monomer having 6 or more polymerizable functional groups is derived.

### <Derivation of Content Molar Ratio of (Meth)acrylic Monomer Having 6 or More Polymerizable Functional Groups>

When the ratio is determined from an electrophotographic photosensitive member, for example, the following method is available. A plurality of sections are peeled only from the surface layer of the electrophotographic photosensitive member with a cutting tool, and the sections are each subjected to composition analysis, such as NMR, ESI-MS, or LC-CAD/MS/MSn, so that a polymerizable monomer having a polymerizable functional group, the monomer forming a composition before the binder resin in the surface layer becomes a polymer, may be identified. Further, the kinds of polymerizable monomers were classified by the number of polymerizable functional groups, and the respective molar ratios were calculated to derive the content molar ratio of the (meth)acrylic monomer having 6 or more polymerizable functional groups.

### <Evaluation of Arithmetic Average Roughness Rz and Average Length Rsm of Elements>

A 5-millimeter square sample piece was cut out of the electrophotographic photosensitive member with a tool such as a saw. At this time, a total of twelve 5-millimeter square sample pieces were cut out of positions determined as follows: positions distant from an end portion of the photosensitive member by 38 mm, 128 mm, and 218 mm in the longitudinal direction thereof were determined, and four points were determined every 90° in the peripheral direction thereof at each of the distances. The sample pieces were fixed to a sample holder so that the surface layer of the electrophotographic photosensitive member was able to be observed. For the sample pieces fixed to the sample holder, the surface profile of a 3-μm square on the surface of the surface layer of the electrophotographic photosensitive member was measured at one location on each of the samples with a scanning probe microscope SPM. This observation was performed on each of the 12 sample pieces, and the arithmetic average of the 10-point average roughnesses thereof based on JIS B0601:2001 was defined as the arithmetic average roughness Rz of the surface of the surface layer of the electrophotographic photosensitive member of the present invention. The average length Rsm of elements was measured by the same method as that for the 10-point average roughness, and the arithmetic average of the 12 sample pieces was defined as the average length Rsm of elements on the surface of the surface layer of the electrophotographic photosensitive member of the present invention.

A scanning probe microscope “JSPM-5200” (manufactured by JEOL Ltd.), a scanning probe microscope “E-sweep” (manufactured by Hitachi High-Tech Corporation), a medium-sized probe microscope system “AFM 5500M” (manufactured by Hitachi High-Tech Corporation), or the like may be used as the SPM.

Conditions for observation with each of the “JSPM-5200” and the “E-sweep” are described below as a specific measurement method. The arithmetic average roughness Rz and the average length Rsm of elements on the surface of the surface layer of the electrophotographic photosensitive member of the present invention were measured by observation with JSPM-5200. The measurement results thereof are shown in Table 3 and Table 4.

Conditions for Observation with “JSPM-5200”

### Scanner: 4

### SPM Scan: All SPM Mode

Cantilever: SI-DF3P2 (manufactured by Hitachi High-Tech Fielding Corporation)
Resonance Frequency Detection: (START) 1.00 kHz, (STOP) 100 kHz (in the case of
f=67 kHz, depending on the kind of cantilever)
Cantilever Autotune: Normal approach

### Acquisition: 2 Inputs (512)

### Scan Mode: Normal

### STM/AFM: AC-AFM

### Clock: 833.33 μs

### Scan Size: 3,000 nm

### Offset: 0

### Bias [V]: 0

Reference/V: unchanged (calibrated value is input)

### Filter: 1.4 Hz

### Loop Gain: 16

The data image of the surface profile was analyzed by the accompanying Win SPM Processing. The 10-point average roughness of each of the samples based on JIS B0601:2001 and the average length Rsm of elements thereof were determined.

In addition, a measurement method including using a scanning probe microscope “E-sweep” (manufactured by Hitachi High-Tech Corporation) is as described below. The measurement can be performed through a scanning operation to output the analyzed image of data on the surface shape.

Conditions for Observation with “E-Sweep”
Cantilever: SI-DF20 (with a back-surface AL) K-A102002771 (manufactured by Hitachi High-Tech Fielding Corporation)
Scanning probe microscope: manufactured by Hitachi High-Tech Science Corporation
Measuring unit: E-sweep
Measurement mode: DFM (resonance mode) shape image
Resolution: number of pieces of X data: 512, number of pieces of Y data: 512
Measurement frequency: 127 Hz

A Q-curve measurement magnification, an exciting voltage, a low-pass filter, a high-pass filter, and the like were adjusted so that the resonance state of the cantilever was able to be optimized.

The image of the surface profile and the surface height data included in the image are analyzed through use of the accompanying software, and the image is subjected to flattening treatment. The difference between the maximum value Zmax and the minimum value Zmin at a height “z” of the image can be determined as the 10-point average roughness based on JIS B0601:2001, and the average length Rsm of elements can be determined.

### <Evaluation of Dynamic Friction Coefficient>

A surface property-measuring machine (model: 14FW, manufacturer: Shinto Scientific Co., Ltd.) was used in the evaluation of the dynamic friction coefficient of the electrophotographic photosensitive member, and the evaluation was performed under a normal-temperature and normal-humidity environment (25° C., 50% RH; hereinafter also referred to as “N/N”). The electrophotographic photosensitive member was attached to the surface property-measuring machine so as to be horizontal, and a urethane piece perpendicularly cut into a 0.2-millimeter thick shape 10.0 mm on a side was brought into abutment with the electrophotographic photosensitive member at an angle of 22.5°. A trial production example of the urethane piece is described later. As the abutting pressure of the urethane piece, the electrophotographic photosensitive member was moved in its longitudinal direction at a speed of 100 mm/min while a dead weight of 10 g was mounted thereon. Thus, a frictional force was measured. The same frictional force measurement was performed except that the weight of the dead weight was changed to 20 g or 50 g. The dynamic friction coefficient was calculated from a relationship between the frictional force obtained by the frictional force measurement and the abutting pressure, and the value was defined as the dynamic friction coefficient of the electrophotographic photosensitive member. The results of the measurement are shown in Table 3 and Table 4.

A method for the trial production of the urethane piece is described below.

27.7 Parts by mass of 4,4′-diphenylmethane diisocyanate (product name: MILLIONATE MT, manufacturer: Tosoh Corporation) and 52.7 parts by mass of a polybutylene adipate polyester polyol having a molecular weight of 2,000 (product name: NIPPOLAN 4010, manufacturer: Nippon Polyurethane Industry Co., Ltd.) were caused to react with each other under a nitrogen atmosphere at 80° C. for 3 hours to provide a prepolymer having an NCO content of 8.8%. In addition, 14.9 parts by mass of a PBA having a molecular weight of 1,000 (product name: NIPPOLAN 4009, manufacturer: Nippon Polyurethane Industry Co., Ltd.), 2.6 parts by mass of 1,4-butanediol (manufacturer: Tokyo Chemical Industry Co., Ltd.), 2.1 parts by mass of trimethylolpropane (manufacturer: Tokyo Chemical Industry Co., Ltd.), and 80 ppm of an isocyanuration catalyst (product name: P15, manufacturer: Air Products Japan K.K.) and 340 ppm of a urethanization catalyst (product name: DABCO crystal, manufacturer: Air Products Japan K.K.) each serving as a catalyst for curing were mixed. Thus, a curing agent was prepared.

The prepolymer and the curing agent were mixed, and the mixture was stirred for 70 seconds while deaeration was performed. The mixed liquid obtained by the stirring was poured into a mold warmed to 135° C., and was pressurized with a vise. At this time, an aluminum-made split mold in which a 0.2-millimeter thick square sheet 200 mm on a side was molded was used as the mold. Under a state in which the mixed liquid was pressurized with the vise, the mixed liquid was left at rest for 90 seconds while being warmed to 135° C. After that, a urethane resin sheet molded into a 0.2-millimeter thick square sheet 200 mm on a side was removed from the mold.

The hardness of the resultant urethane resin sheet was measured with a Wallace microhardness meter (manufacturer: H. W. Wallace & Co Limited) based on JIS

K 6253. The measurement was performed at nine points serving as points of intersection of positions distant from a horizontal side of the urethane resin sheet by 50 mm, 100 mm, and 150 mm, and positions distant from a vertical side thereof by 50 mm, 100 mm, and 150 mm, and the average value of the measured values was defined as the hardness of the urethane resin sheet.

The hardness obtained at this time was 68 (IRHD®).

The urethane resin sheet was perpendicularly cut so as to be a square sheet 10.0 mm on a side. Thus, the urethane piece perpendicularly cut into a 0.2-millimeter thick shape 10.0 mm on a side was obtained.

### <Evaluation of Tackiness>

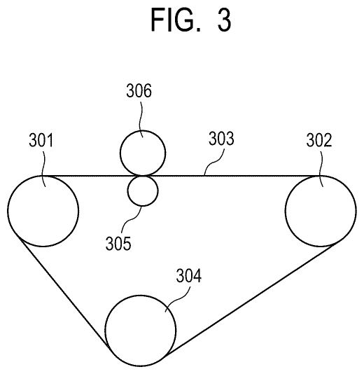

In order to evaluate the tackiness between an electrophotographic photosensitive member and a transfer member, measurement was performed under an N/N environment with a jig illustrated in FIG. 3. An electrophotographic belt 303, which is the transfer member, is tensioned by a drive roller 301 having a motor and a torque meter, a driven roller 302, and a tension roller 304 that applies tension to the electrophotographic belt 303. The same backup roller as that used in an electrophotographic apparatus (product name: i-SENSYS MF754Cdw, manufacturer: Canon Inc.) was used as a backup roller 305, and the intermediate transfer member 1 described in Japanese Patent Application Laid-Open No. 2019-211774 was used as the electrophotographic belt 303. Thus, an electrophotographic photosensitive member 306 was evaluated.

The electrophotographic belt 303 was rotated at 180 mm/sec under a state in which no photosensitive drum was brought into contact therewith, and the torque value at this time was measured. This value is represented by “Tq1”.

Next, while the electrophotographic belt 303 was rotated at 180 mm/sec, the maximum value of torque when the electrophotographic photosensitive member 306 was brought into contact with the belt at 700 gf was measured. This value is represented by “Tq2”.

Then, the difference between the “Tq2” and the “Tq1” was defined as a tackiness index for evaluating the tackiness between the electrophotographic belt 303 and the electrophotographic photosensitive member 306. The measurement results are shown in Table 3 and Table 4.

For the evaluation of the tackiness index, a new electrophotographic belt was used.

In addition, the electrophotographic belt and the electrophotographic photosensitive member were brought into contact with each other under a state in which the photosensitive drum was fixed without being rotated, and the contact surface of the electrophotographic photosensitive member was certainly brought into a pristine state.

### <Horizontal Streak Evaluation>

To evaluate a horizontal streak image due to the slipping of the electrophotographic photosensitive member, the evaluation was performed with an electrophotographic apparatus (product name: i-SENSYS MF754Cdw, manufacturer: Canon Inc.) in an N/N environment. The image forming apparatus was reconstructed so that the conveying speed of a recording material, the peripheral speed of an intermediate transfer member, and the peripheral speed of the electrophotographic photosensitive member were able to be adjusted.

The image forming apparatus, a toner cartridge to be used in the image forming apparatus, the electrophotographic photosensitive member, and a letter-size recording material (product name: XEROX Vitality, manufacturer: Xerox Corporation, basis weight: 75 g/m²) were left to stand in the N/N environment for 24 hours. After that, the electrophotographic photosensitive member was attached to the toner cartridge, and the resultant was attached to the image forming apparatus.

The conveying speed of the recording material, the peripheral speed of the intermediate transfer member, and the peripheral speed of the electrophotographic photosensitive member were set to 300 mm/sec, 300 mm/sec, and 291 mm/sec, respectively. In other words, a difference between the peripheral speeds of the intermediate transfer member and the electrophotographic photosensitive member was set to 3%. The electrophotographic photosensitive members in all the toner cartridges for yellow, magenta, cyan, and black colors were identical to each other.

To output an evaluation image, as the initial stage of printing, first, a halftone image (toner laid-on level: 0.2 mg/cm²) in which margins each having a width of 5.0 mm were arranged on its upper, lower, left, and right sides was printed on one sheet of the recording material with cyan toner. After a full-color image having a print percentage of 1.0% had been printed on 100,000 sheets thereof, the same halftone image as that at the initial stage of the printing was printed as an evaluation image at the later stage of the printing on one sheet thereof. The halftone image was evaluated for a horizontal streak by the following criteria. A level equal to or higher than an evaluation criterion C is the level at which no problem occurs in practical use. The results of the evaluation are shown in Table 3 and Table 4.

### (Evaluation Criteria)

A: No horizontal streak is observed by observation with a loupe.

B: No horizontal streak is observed by visual observation, but a horizontal streak is slightly observed by observation with a loupe.

C: A horizontal streak is slightly observed by visual observation.

D: A horizontal streak is observed by visual observation.

TABLE 3

| | Kind of | | | Dynamic | | |
|---|---|---|---|---|---|---|
| | electrophotographic | Rz | Rsm | friction | Tackiness | Image |
| Example | photosensitive member | [nm] | [nm] | coefficient | index | rank |
| 1 | Electrophotographic | 308 | 246 | 0.60 | 4.3 × 10⁻² | A |
| | photosensitive member 1 | | | | | |
| 2 | Electrophotographic | 324 | 281 | 0.58 | 4.3 × 10⁻² | A |
| | photosensitive member 2 | | | | | |
| 3 | Electrophotographic | 277 | 220 | 0.61 | 4.3 × 10⁻² | A |
| | photosensitive member 3 | | | | | |
| 4 | Electrophotographic | 310 | 254 | 0.62 | 5.0 × 10⁻² | B |
| | photosensitive member 4 | | | | | |
| 5 | Electrophotographic | 323 | 277 | 0.60 | 5.0 × 10⁻² | B |
| | photosensitive member 5 | | | | | |
| 6 | Electrophotographic | 285 | 223 | 0.63 | 5.0 × 10⁻² | B |
| | photosensitive member 6 | | | | | |
| 7 | Electrophotographic | 301 | 246 | 0.60 | 5.3 × 10⁻² | B |
| | photosensitive member 7 | | | | | |
| 8 | Electrophotographic | 318 | 271 | 0.59 | 5.3 × 10⁻² | B |
| | photosensitive member 8 | | | | | |
| 9 | Electrophotographic | 282 | 226 | 0.61 | 5.3 × 10⁻² | B |
| | photosensitive member 9 | | | | | |
| 10 | Electrophotographic | 297 | 245 | 0.63 | 4.3 × 10⁻² | A |
| | photosensitive member 10 | | | | | |
| 11 | Electrophotographic | 303 | 248 | 0.63 | 5.0 × 10⁻² | B |
| | photosensitive member 11 | | | | | |
| 12 | Electrophotographic | 325 | 281 | 0.61 | 5.0 × 10⁻² | B |
| | photosensitive member 12 | | | | | |
| 13 | Electrophotographic | 287 | 221 | 0.64 | 5.0 × 10⁻² | B |
| | photosensitive member 13 | | | | | |
| 14 | Electrophotographic | 174 | 254 | 0.65 | 4.5 × 10⁻² | B |
| | photosensitive member 14 | | | | | |
| 15 | Electrophotographic | 195 | 273 | 0.64 | 4.5 × 10⁻² | B |
| | photosensitive member 15 | | | | | |
| 16 | Electrophotographic | 152 | 228 | 0.65 | 4.5 × 10⁻² | B |
| | photosensitive member 16 | | | | | |
| 17 | Electrophotographic | 151 | 103 | 0.70 | 4.5 × 10⁻² | C |
| | photosensitive member 17 | | | | | |
| 18 | Electrophotographic | 288 | 241 | 0.62 | 6.0 × 10⁻² | C |
| | photosensitive member 18 | | | | | |
| 19 | Electrophotographic | 388 | 394 | 0.62 | 4.2 × 10⁻² | A |
| | photosensitive member 19 | | | | | |
| 20 | Electrophotographic | 395 | 397 | 0.61 | 4.2 × 10⁻² | A |
| | photosensitive member 20 | | | | | |
| 21 | Electrophotographic | 380 | 390 | 0.63 | 4.2 × 10⁻² | A |
| | photosensitive member 21 | | | | | |
| 22 | Electrophotographic | 156 | 106 | 0.68 | 4.5 × 10⁻² | A |
| | photosensitive member 22 | | | | | |
| 23 | Electrophotographic | 383 | 392 | 0.62 | 4.2 × 10⁻² | A |
| | photosensitive member 23 | | | | | |
| 24 | Electrophotographic | 288 | 255 | 0.64 | 4.5 × 10⁻² | B |
| | photosensitive member 24 | | | | | |
| 25 | Electrophotographic | 290 | 249 | 0.62 | 4.5 × 10⁻² | B |
| | photosensitive member 25 | | | | | |
| 26 | Electrophotographic | 292 | 252 | 0.63 | 4.5 × 10⁻² | B |
| | photosensitive member 26 | | | | | |
| 27 | Electrophotographic | 296 | 255 | 0.63 | 4.5 × 10⁻² | B |
| | photosensitive member 27 | | | | | |
| 28 | Electrophotographic | 294 | 254 | 0.63 | 4.5 × 10⁻² | B |
| | photosensitive member 28 | | | | | |
| 29 | Electrophotographic | 364 | 267 | 0.60 | 4.3 × 10⁻² | A |
| | photosensitive member 29 | | | | | |
| 30 | Electrophotographic | 366 | 264 | 0.61 | 4.3 × 10⁻² | A |
| | photosensitive member 30 | | | | | |
| 31 | Electrophotographic | 287 | 271 | 0.61 | 4.7 × 10⁻² | A |
| | photosensitive member 31 | | | | | |

TABLE 4

| | Kind of | | | Dynamic | | |
|---|---|---|---|---|---|---|
| Comparative | electrophotographic | Rz | Rsm | friction | Tackiness | Image |
| Example | photosensitive member | [nm] | [nm] | coefficient | index | rank |
| 1 | Electrophotographic | 136 | 91 | 0.74 | 5.2 × 10⁻² | D |
| | photosensitive member c1 | | | | | |
| 2 | Electrophotographic | 357 | 284 | 0.61 | 5.1 × 10⁻² | D |
| | photosensitive member c2 | | | | | |
| 3 | Electrophotographic | 133 | 92 | 0.72 | 4.4 × 10⁻² | D |
| | photosensitive member c3 | | | | | |
| 4 | Electrophotographic | 352 | 282 | 0.57 | 4.3 × 10⁻² | D |
| | photosensitive member c4 | | | | | |
| 5 | Electrophotographic | 287 | 88 | 0.64 | 6.4 × 10⁻² | D |
| | photosensitive member c5 | | | | | |
| 6 | Electrophotographic | 324 | 287 | 0.61 | 6.2 × 10⁻² | D |
| | photosensitive member c6 | | | | | |
| 7 | Electrophotographic | 129 | 99 | 0.75 | 5.3 × 10⁻² | D |
| | photosensitive member c7 | | | | | |
| 8 | Electrophotographic | 327 | 287 | 0.59 | 5.3 × 10⁻² | D |
| | photosensitive member c8 | | | | | |
| 9 | Electrophotographic | 136 | 92 | 0.76 | 5.0 × 10⁻² | D |
| | photosensitive member c9 | | | | | |
| 10 | Electrophotographic | 341 | 279 | 0.61 | 4.9 × 10⁻² | D |
| | photosensitive member c10 | | | | | |
| 11 | Electrophotographic | 155 | 81 | 0.72 | 4.5 × 10⁻² | D |
| | photosensitive member c11 | | | | | |
| 12 | Electrophotographic | 207 | 225 | 0.61 | 4.4 × 10⁻² | D |
| | photosensitive member c12 | | | | | |
| 13 | Electrophotographic | 83 | 76 | 0.80 | 4.7 × 10⁻² | D |
| | photosensitive member c13 | | | | | |
| 14 | Electrophotographic | 131 | 103 | 0.78 | 4.7 × 10⁻² | D |
| | photosensitive member c14 | | | | | |
| 15 | Electrophotographic | 645 | 621 | 0.55 | 4.2 × 10⁻² | D |
| | photosensitive member c15 | | | | | |
| 16 | Electrophotographic | 678 | 667 | 0.52 | 4.1 × 10⁻² | D |
| | photosensitive member c16 | | | | | |
| 17 | Electrophotographic | 284 | 225 | 0.66 | 6.2 × 10⁻² | D |
| | photosensitive member c17 | | | | | |
| 18 | Electrophotographic | 322 | 274 | 0.62 | 6.4 × 10⁻² | D |
| | photosensitive member c18 | | | | | |

According to the present invention, there can be provided an electrophotographic photosensitive member that can resist mass printing by creating an appropriate surface state for the electrophotographic photosensitive member through use of a (meth)acrylic monomer having 6 or more polymerizable functional groups and an inorganic particle in the surface design of the electrophotographic photosensitive member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electrophotographic photosensitive member comprising a surface layer containing a binder resin and an inorganic particle,
wherein a value of a ratio of a volume of the inorganic particle to a volume of the binder resin in the surface layer is 1.0 or more and 4.0 or less,
wherein the binder resin is a polymerization product of a polymerizable monomer composition containing a polymerizable monomer having a polymerizable functional group,
wherein the polymerizable monomer composition contains a (meth)acrylic monomer having 6 or more polymerizable functional groups as the polymerizable monomer,
wherein the (meth)acrylic monomer having 6 or more polymerizable functional groups has a molecular weight of 540 or more and 1,300 or less,
wherein a content of the (meth)acrylic monomer having 6 or more polymerizable functional groups in the polymerizable monomer composition is 40 mol % or more with respect to a total molar number of the polymerizable monomer in the polymerizable monomer composition, and
wherein a surface of the surface layer has an arithmetic average roughness Rz of 150 nm or more and 400 nm or less.

2. The electrophotographic photosensitive member according to claim 1, wherein the surface layer has a dynamic friction coefficient of 0.70 or less.

3. The electrophotographic photosensitive member according to claim 1, wherein the surface layer has a tackiness index of 0.060 or less.

4. The electrophotographic photosensitive member according to claim 1, wherein the inorganic particle contained in the surface layer have a number-based average primary particle diameter of 80 nm or more and 300 nm or less.

5. The electrophotographic photosensitive member according to claim 1,
wherein the surface layer contains inorganic particle A and inorganic particle B having different number-based average primary particle diameters as the inorganic particle, and
wherein, when the number-based average primary particle diameter of the inorganic particle A is represented by DA [nm], and the number-based average primary particle diameter of the inorganic particle B is represented by DB [nm], the DA and the DB satisfy the following formulae (i) and (ii):
$$1.3 \leq DA / DB \leq 3.8 \qquad ( i )$$
$$and$$
$$100 \leq DA \leq 300. \qquad ( ii )$$

6. The electrophotographic photosensitive member according to claim 1, wherein the polymerizable monomer composition further contains polymerizable monomer A represented by the following formula (1) as the polymerizable monomer: 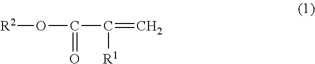
where R¹ represents a hydrogen atom or a methyl group, and R² represents an alkyl group having 10 to 20 or less carbon atoms.

7. The electrophotographic photosensitive member according to claim 1, wherein elements of the surface of the surface layer have an average length Rsm of 100 nm or more and 400 nm or less.

8. The electrophotographic photosensitive member according to claim 1, wherein the inorganic particle contained in the surface layer is silica particle.

9. A process cartridge comprising an electrophotographic photosensitive member and at least one unit selected from the group consisting of: a charging unit; a developing unit; and a cleaning unit,
the process cartridge integrally supporting the electrophotographic photosensitive member and the at least one unit, and being detachably attachable onto a main body of an electrophotographic apparatus,
wherein the electrophotographic photosensitive member includes a surface layer containing a binder resin and an inorganic particle,
wherein a value of a ratio of a volume of the inorganic particle to a volume of the binder resin in the surface layer is 1.0 or more and 4.0 or less,
wherein the binder resin is a polymerization product of a polymerizable monomer composition containing a polymerizable monomer having a polymerizable functional group,
wherein the polymerizable monomer composition contains a (meth)acrylic monomer having 6 or more polymerizable functional groups as the polymerizable monomer,
wherein the (meth)acrylic monomer having 6 or more polymerizable functional groups has a molecular weight of 540 or more and 1,300 or less,
wherein a content of the (meth)acrylic monomer having 6 or more polymerizable functional groups in the polymerizable monomer composition is 40 mol % or more with respect to a total molar number of the polymerizable monomer in the polymerizable monomer composition, and
wherein a surface of the surface layer has an arithmetic average roughness Rz of 150 nm or more and 400 nm or less.

10. An electrophotographic apparatus comprising:
an electrophotographic photosensitive member;
a charging unit;
an exposing unit;
a developing unit; and
a transferring unit,
wherein the electrophotographic photosensitive member includes a surface layer containing a binder resin and an inorganic particle,
wherein a value of a ratio of a volume of the inorganic particle to a volume of the binder resin in the surface layer is 1.0 or more and 4.0 or less,
wherein the binder resin is a polymerization product of a polymerizable monomer composition containing a polymerizable monomer having a polymerizable functional group,
wherein the polymerizable monomer composition contains a (meth)acrylic monomer having 6 or more polymerizable functional groups as the polymerizable monomer,
wherein the (meth)acrylic monomer having 6 or more polymerizable functional groups has a molecular weight of 540 or more and 1,300 or less,
wherein a content of the (meth)acrylic monomer having 6 or more polymerizable functional groups in the polymerizable monomer composition is 40 mol % or more with respect to a total molar number of the polymerizable monomer in the polymerizable monomer composition, and
wherein a surface of the surface layer has an arithmetic average roughness Rz of 150 nm or more and 400 nm or less.
